(19) United States
(12) Patent Application Publication
(10) Pub. No.: US 2026/0088017 A1
(43) Pub. Date: Mar. 26, 2026

(54) TRANSFORMING INPUT SEQUENCES TO OUTPUT SEQUENCES NON-AUTOREGRESSIVELY USING MACHINE LEARNING

(71) Applicant: NVIDIA Corporation, Santa Clara, CA (US)

(72) Inventors: Hainan XU, New York, NY (US); Boris GINSBURG, Sunnyvale, CA (US)

(21) Appl. No.: 18/895,198

(22) Filed: Sep. 24, 2024

(51) Int. Cl. G10L 15/06; G10L 15/26

(52) U.S. Cl. CPC G10L 15/063; G10L 15/26

(57) ABSTRACT

In various examples, a technique for transforming an input sequence to an output sequence using a machine learning model is disclosed. The technique includes encoding a sequence of inputs in a representation of the sequence of inputs. The technique also includes causing the generation of a sequence of joint probabilities based on the representation of the sequence of inputs and no history of previously predicted output labels. The technique also includes causing the generation of a sequence of output labels based on the sequence of joint probabilities.

### BACKGROUND

Machine learning (ML) models can transform an input sequence to an output sequence (e.g., predicting an output sequence based on an input sequence), such as when performing speech to text (STT) transformation in speech recognition, text to text (TTT) transformation in machine translation, text to speech (TTS) in speech synthesis, etc.

Some existing ML models assume conditional independence between predicted outputs and predict during inference each output in a sequence of predicted outputs without regard to previously predicted output(s). The prediction operations (also referred to as “inference operations”) in such ML models are typically performed solely by an encoder (e.g., implemented as a neutral network). Such ML models are often referred to as non-autoregressive (NAR) models. For example, a connectionist temporal classification (CTC) model is such a NAR model used to perform automatic speech recognition. Because a NAR model assumes conditional independence between predicted outputs, prediction of outputs can be performed in parallel and computationally efficient manner. However, due to such parallelized processing, outputs are predicted without the context of the previously predicted outputs and, thus, the accuracy of such predicted outputs may not be satisfactory.

Some other existing ML models assume conditional dependence between predicted outputs and predict each output in a sequence of predicted outputs based on previously predicted output(s) during inference. Such ML models are often referred to as autoregressive (AR) models. Due to the autoregressive nature of these models, prediction of outputs can benefit from the context of the previously predicted outputs and hence prove to be more accurate than the NAR models. One type of such AR models includes an encoder (also referred to as a transcription network), a predictor (also referred to as a prescription network or a decoder), and a joiner (also referred to as a joint network). Such AR models are often referred to as transducer models (e.g., recurrent neutral network (RNN)-transducer (RNN-T) models).

During inference, given an input sequence, the encoder of a conventional transducer model can extract a higher-level representation of the input sequence (also referred to as “input embeddings”) from the input sequence. The input embeddings can be implemented as vectors or tensors that represent higher-level feature(s) of the input sequence. Given a sequence of one or more output labels previously predicted by the transducer model, the predictor outputs a higher-level representation of the next output (also referred to as “next output embeddings”). Given the input embeddings from the encoder and the next output embeddings from the predictor, the joiner can combine the embeddings and cause the generation of a probability distribution over all the output labels. Specifically, the probability distribution can indicate the probability of each of the output labels being emitted as an output of the model. Given the probability distribution, the transducer model can emit the next output label. In such a manner, the model can process one input at a time and accordingly emit a next output label.

A conventional transducer model described above can be trained to transform an audio signal including speech information to text (e.g., as part of speech recognition). In such a transducer model, the input sequence can be a sequence of audio inputs (e.g., input audio frames) in the audio signal. The output sequence can be a sequence of text outputs (also referred to as text labels, labels, text tokens, or non-blank tokens). The text tokens can include sub words that form a word and/or words that form a sentence. All the possible text tokens and a blank token can form a token vocabulary for the model. During inference, given the embeddings representing an input audio frame and the next text token predicted by the predictor, the joiner of the transducer model can generate a probability distribution over the token vocabulary of the model. Specifically, the probability distribution can indicate the probability of each of the possible text tokens or a blank token being emitted as an output of the model. Given the probability distribution, the transducer model can emit the next text token or a blank token. In such a manner, the transducer model can process one input audio frame at a time and accordingly emit a next text token or a blank token.

To put the above description of a conventional transducer model in context, although inference accuracy of such a model is improved in comparison to the NAR models described above, due to its autoregressive nature, its inference operation is not as computationally efficient as the AR models. In particular, because emission of each next output is based on previously predicted output(s), the inference operation cannot be parallelized like the NAR models.

As such, a need exists for more effective techniques for improving the computational efficiency of conventional transducer models.

### SUMMARY

Embodiments of the present disclosure relate to transforming input sequences to output sequences non-autoregressively using machine learning. The techniques described herein include encoding a sequence of inputs in a representation of the sequence of inputs. The technique also includes causing the generation of a sequence of joint probabilities based on the representation of the sequence of inputs and no history of previously predicted output labels. The technique also includes causing the generation of a sequence of output labels based on the sequence of joint probabilities.

The disclosed technique provides several technical advantages relative to prior approaches. In particular, because the disclosed technique trains a transducer model to transform a sequence of inputs to a sequence of outputs non-autoregressively, the transducer model is capable of operating more computationally efficient than a conventional transducer model. In addition, because the disclosed technique configures the transducer model, for each predicted output label, to output a predicted duration (e.g., the number of inputs predicted to correspond the predicted output label), the transducer model is capable of skipping processing of these inputs and thus operates with further improved computational efficiency in comparison a conventional transducer model.

### BRIEF DESCRIPTION OF THE DRAWINGS

The present systems and methods for transforming input sequences to output sequences non-autoregressively using machine learning are described in detail below with reference to the attached drawing figures, wherein:

FIG. 1 illustrates a system configured to implement one or more aspects of the various embodiments;

FIG. 2 is an illustration of an example process of training a transducer model, according to various embodiments;

FIG. 3 is a more detailed illustration of some operations of an example process of training a transducer model, according to at least one embodiment;

FIG. 4 is an illustration of an example inference process using a transducer model, according to various embodiments;

FIG. 5A is a flow diagram showing a method, according to various embodiments;

FIG. 5B is a flow diagram showing a method, according to various embodiments;

FIG. 6A is an illustration of an example autonomous vehicle, in accordance with some embodiments of the present disclosure;

FIG. 6B is an example of camera locations and fields of view for the example autonomous vehicle of FIG. 6A, in accordance with some embodiments of the present disclosure;

FIG. 6C is a block diagram of an example system architecture for the example autonomous vehicle of FIG. 6A, in accordance with some embodiments of the present disclosure;

FIG. 6D is a system diagram for communication between cloud-based server(s) and the example autonomous vehicle of FIG. 6A, in accordance with some embodiments of the present disclosure;

FIG. 7A is a block diagram of an example generative language model system suitable for use in implementing at least some embodiments of the present disclosure;

FIG. 7B is a block diagram of an example generative language model that includes a transformer encoder-decoder suitable for use in implementing at least some embodiments of the present disclosure;

FIG. 7C is a block diagram of an example generative language model that includes a decoder-only transformer architecture suitable for use in implementing at least some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

Techniques of a transducer model are disclosed for non-autoregressively inferring a sequence of outputs from a sequence of inputs. Specifically, during inference, in non-limiting embodiments, the joiner of the transducer model is configured to receive, as input, output of the encoder of the transducer model only and does not receive any input corresponding to the history of previous outputs of the transducer model. By configuring the joiner of the transducer model to operate based solely on output of the encoder (and not the historical outputs), the transducer model can operate non-autoregressively, namely, transforming a sequence of inputs to a sequence of output based solely on the sequence of inputs.

To train a transducer model to operate non-autoregressively, during training, a masking operation (e.g., a binary mask operation) is applied to the output of the predictor of the transducer model at random according to a given probability (e.g., a pre-defined probability). The masking operation effectively blocks the output of the predictor from being provided to the joiner of the transducer model. The probability with which the masking operation is applied can be set to any suitable value (e.g., at 50%). In such a manner, when the masking operation is applied, the transducer model is being trained to transform input sequence(s) to output sequence(s) based solely on the output of the encoder, like the CTC model described above. Accordingly, such training enables the transducer model to also operate as such during inference, e.g., when the joiner of the transducer model is configured to receive no input from the predictor. In addition, when the masking operation is not applied, the transducer model is being trained to transform input sequence(s) to output sequence(s) based on the output of the encoder and the output of the predictor, like a conventional transducer model. Accordingly, such training enables the transducer model to also operate as such during inference, e.g., when the joiner of the transducer model is configured to receive input from the predictor.

The disclosed technique provides several technical advantages relative to prior approaches. In particular, because the disclosed technique trains a transducer model to transform a sequence of inputs to a sequence of outputs non-autoregressively, the transducer model is capable of operating more computationally efficient than a conventional transducer model. In addition, because the disclosed technique configures the transducer model, for each predicted output label, to output a predicted duration (e.g., the number of inputs predicted to correspond the predicted output label), the transducer model is capable of skipping processing of these inputs and thus operates with further improved computational efficiency in comparison a conventional transducer model.

In some examples, the machine learning models described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model (e.g., weights and biases). In some instances, such as where the machine learning model is small enough (e.g., has a small enough number of parameters), the model may be included within the container itself. In other examples—such as where the model is large—the model may be hosted/stored in the cloud (e.g., in a data center) and/or may be hosted on-premises and/or at the edge (e.g., on a local server or computing device, but outside of the container). In some embodiments, the machine learning models described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

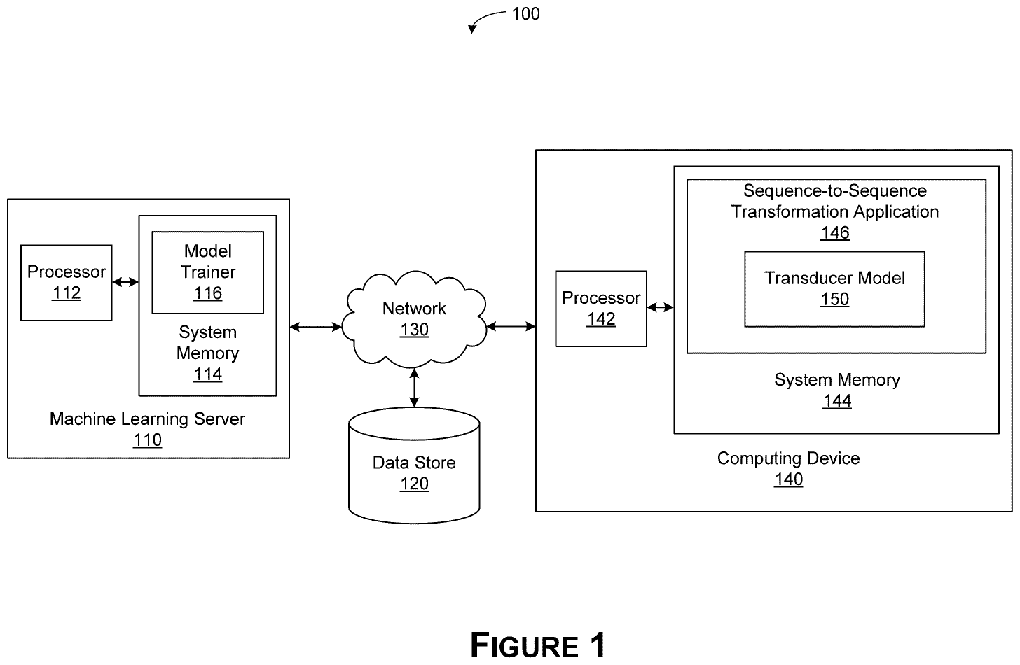

FIG. 1 illustrates a system 100 configured to implement one or more aspects of the various embodiments. As shown, the system 100 includes a machine learning server 110, a data store 120, and a computing device 140 in communication over a network 130, which can be a wide area network (WAN) such as the Internet, a local area network (LAN), or any other suitable network.

As shown, a model trainer 116 executes on a processor 112 of the machine learning server 110 and is stored in a system memory 114 of the machine learning server 110. The processor 112 receives user input from input devices, such as a keyboard, a mouse, a joystick, a touchscreen, or a microphone. In operation, the processor 112 is the master processor of the machine learning server 110, controlling and coordinating operations of other system components. In particular, the processor 112 can issue commands that control the operation of a graphics processing unit (GPU) (not shown) that incorporates circuitry optimized for graphics and video processing, including, for example, video output circuitry. The GPU can deliver pixels to a display device that can be any conventional cathode ray tube, liquid crystal display, light-emitting diode display, or the like.

The system memory 114 of the machine learning server 110 stores content, such as software applications and data, for use by the processor 112 and the GPU. The system memory 114 can be any type of memory capable of storing data and software applications, such as a random access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, or any suitable combination of the foregoing.

It will be appreciated that the machine learning server 110 shown herein is illustrative and that variations and modifications are possible. For example, the number of processors 112, the number of GPUs, the number of system memories 114, and the number of applications included in the system memory 114 can be modified as desired. Further, the connection topology between the various units in FIG. 1 can be modified as desired. In some embodiments, any combination of the processor 112, the system memory 114, and a GPU can be replaced with any type of virtual computing system, distributed computing system, or cloud computing environment, such as a public, private, or a hybrid cloud.

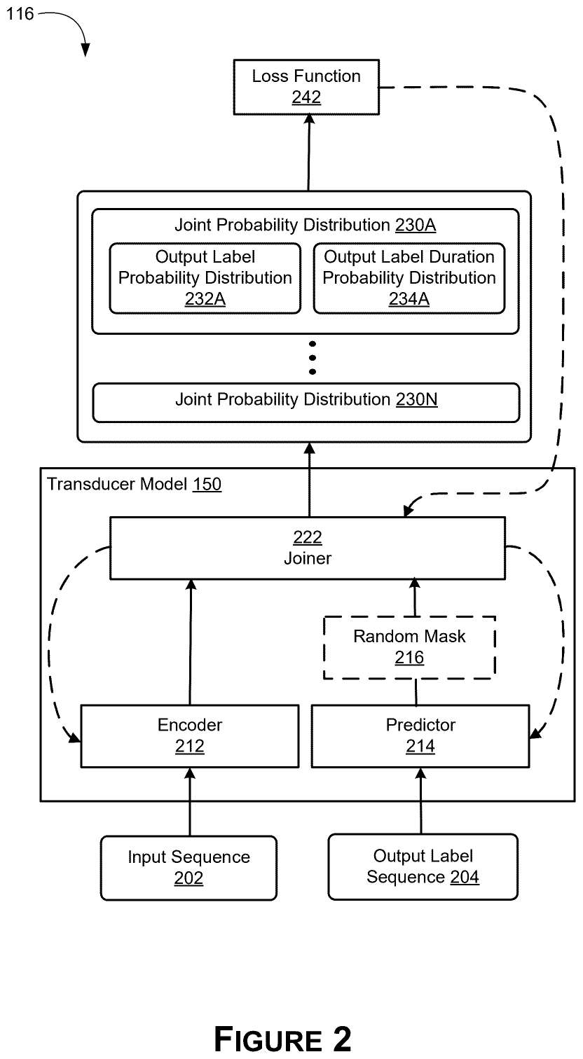

In some embodiments, the model trainer 116 is configured to train one or more machine learning models, including a transducer model 150. The transducer model 150 is a machine learning model that transforms a sequence of inputs to a sequence of outputs. An example architecture of the transducer model 150, and techniques for training the same, are discussed in greater detail below in conjunction with FIGS. 2-4 and 5A-B. Training data and/or trained machine learning models, including the transducer model 150, can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in some embodiments the machine learning server 110 can include the data store 120.

Once trained, the transducer model 150 can be deployed for inference, e.g., transforming a sequence of inputs to a sequence of outputs. Illustratively, a sequence-to-sequence transformation application 146 that utilizes the transducer model 150 is stored in a system memory 144, and executes on a processor 142, of the computing device 140. In some embodiments, components of the computing device 140, including the system memory 144 and the processor 142 can be similar to corresponding components of the machine learning server 110.

It will be appreciated that the system 100 shown herein is illustrative and that variations and modifications are possible. For example, the number of machine learning servers and computing devices can be modified as desired. Further, the functionality included in any of the applications can be divided across any number of applications or other software that are stored and executed via any number of computing systems that are located in any number of physical locations.

FIG. 2 is an illustration of an example process of training the transducer model 150 of FIG. 1, according to various embodiments. As shown, such a process is performed in the model trainer 116 of FIG. 1 with respect to the transducer model 150. The transducer model 150 includes an encoder 212, a predictor 214, and a joiner 222. Each of the encoder 212, predictor 214, and joiner 222 can be implemented as a suitable neutral network. For example, the encoder 212 can be implemented as a recurrent neutral network, such as a long short-term memory (LSTM) network, a transformer, a conformer, and the like. The predictor 214 can also be implemented as a recurrent neutral network, such as a LSTM network. The joiner 222 can be implemented as a conventional neutral network (e.g., a feedforward neutral network). The encoder 212, predictor 214, and joiner 222 can be trained according to a loss function 242.

During training, the transducer model 150 can receive, as input, one or more pairs of an input sequence 202 and an output label sequence 204, as training data. Each pair of an input sequence 202 and an output label sequence 204 is used to train the transducer model 150 to transform the input sequence 202 to the output label sequence 204. Specifically, the transducer model 150 is trained to align a portion of the input sequence 202 (e.g., of one or more consecutive inputs) to a respective portion of the output label sequence 204 (e.g., one or more consecutive output labels). Once trained as such, during inference, the transducer model 150 can predict output label(s) when given input(s) in a given input sequence.

In at least one embodiment, each input in an input sequence 202 and each output label in an output label sequence 204 are represented as a vector or tensor (e.g., a fixed-length real-valued vector or tensor). For example, in one embodiment, the transducer model 150 is trained to transform sequences(s) of audio inputs (e.g., audio frames in an audio signal that includes speech information) to respective sequence(s) of text output labels (e.g., sub words). In such an embodiment (referred to hereinafter as the automatic speech recognition (ASR) embodiment), each input audio frame can be represented by a vector encoding an audio frame (e.g., using mel-frequency cepstral (MFC) coefficients) and each output label can be represented by a vector encoding a text output label (e.g., a sub word). A vector encoding an output text label can be a one-hot vector with all elements but one having a zero value, where the non-zero element has a value that represents the text output label.

Output labels in an output label sequence 204 belong to a vocabulary of output labels for the transducer model 150 (also referred to as the vocabulary of the transducer model 150). The vocabulary of the transducer model 150 includes all the possible output labels that the model is allowed to output. Output of the model is also referred to herein as emission of the model. At least in some embodiments, the vocabulary can include a blank output label that is used to represent a null output (or put another way, for when the model outputs nothing) given one or more inputs. For example, in the ASR embodiment described herein, the length of an input sequence 202 (e.g., the number of audio frames in an audio signal) is typically greater than the length of a corresponding output label sequence 204 (e.g., the number of output text labels in a text sequence). In such a case, the vocabulary of the transducer model 150 can include a blank output label (also referred to as a blank token or a blank, which is sometimes represented by a symbol ‘Ø’) in addition to text output labels (also referred to as text tokens, non-blank tokens, or tokens). Blank output labels are used to represent an alignment between an input sequence and an output label sequence. For example, when a portion of an audio signal (e.g., one or more input audio frames) does not include any speech information, the transducer model 150 can indicate such a portion is to be transformed to nothing, e.g., by outputting one or more blank tokens. When a portion of an audio signal includes speech information, the transducer model 150 can indicate such a portion is to be transformed to a text output label, e.g., by outputting a text output label. In such a manner, an alignment between a sequence of audio frames and a text sequence is represented by a sequence of text output labels augmented by blank symbols and represents how the sequence of audio frames is transformed to the text sequence.

In at least one embodiment, the transducer model 150 is trained in a batch mode. Specifically, a batch of input sequences 202 and a corresponding batch of output label sequences 204 are fed to the transducer model 150 as input to train the transducer model 150. For example, in the ASR embodiment described herein, each batch of input sequences and a corresponding batch of output sequences can be a sequence of input audio frames and a corresponding sequence of words that form a sentence, respectively.

Given an input sequence 202, the encoder 212 can encode the input sequence in a representation of the input sequence. Specifically, the encoder 212 can extract feature(s) in each input in the input sequence and encodes the input in a higher-level representation of the feature(s) (e.g., using a feature vector). For example, in the ASR embodiment described herein, the higher-level representation of the input features can represent the acoustic features of the input audio frames.

Given an output label sequence 204, the predictor 214 can output a representation of a sequence of predicted output labels. Specifically, the predictor 214 can extract the context information among the inputs and generates a higher-level representation of a sequence of predicted output labels (e.g., using a feature vector to represent each predicted output label). For example, in the ASR embodiment described herein, the high-level representation can represent a sequence of predicted text output labels.

Given the output of the predictor 214, the transducer model 150 can mask portions (e.g., all portions) of the output at random according to a given probability. Specifically, a random mask 216 (e.g., a binary mask) can be applied to the output of the predictor 214 at random with a predefined probability (e.g., 0.5). For example, if a representation of a sequence of predicted output labels is implemented as a sequence of U feature vectors that each is of size K, such a sequence has a dimension of [U, K]. In such an example, the random mask 216 can be implemented as a two-dimensional (2D) vector with a dimension of [U, K], where each element of the vector has a value 0. In a first probabilistic event that the mask is not applied, the output of the predictor 214 can serve as an input to the downstream processing of the transducer model 150. In such an event, the output of the encoder 212 and the regular output of the predictor 214 are provided to the joiner 222 to cause the generation of a set of joint probabilities 230A-N. In a second probabilistic event that such a mask is applied to the sequence of feature vectors (e.g., using a bitwise operation AND), all elements of each of the U feature vectors in the sequence of feature vectors will be set to a value 0. In such a manner, the output of the predictor 214 is effectively removed from the downstream processing of the transducer model 150.

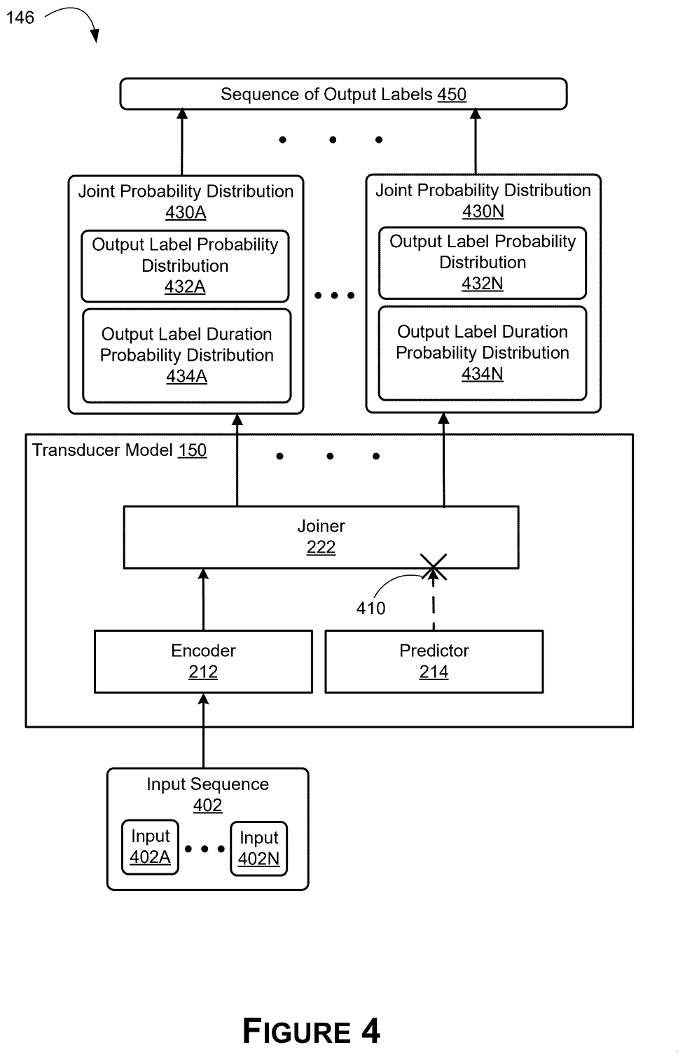

Specifically, if the transducer model 150 determines that the first probabilistic event has occurred, given the output of the encoder 212 and the regular output of the predictor 214, the joiner 222 generates a pair of outputs for each possible permutation of a position in the input sequence 202 and a position in the output sequence 204. A first output of the pair includes a distribution over the output label vocabulary of the model given such a permutation while a second output includes a distribution over a set of allowed durations for the model given the same permutation. Each allowed duration of the set of allowed durations indicates a possible number of inputs that are allowed to be processed to generate an output label. To generate such pairs of distributions, any suitable probability density function can be implemented. In contrast to the conventional transducer model described above, the transducer model 150 is configured as such to additionally output the predicted duration for a predicted output label and is thus enabled to operate more computationally efficient during inference than the conventional transducer model, as will be described in more detail with respect to FIG. 4. Given its dual output, the transducer model 150 is sometimes referred to as a token-and-duration transducer (TDT) model.

Once such pairs of distributions are generated, the distribution values can be normalized such that all values in any given distribution add up to a probability of 1 (e.g., using a SoftMax function). Each such pair of normalized probability distributions can form a joint probability distribution (e.g., as a product of the two normalized probability distributions). Each element of the set of joint probability distributions 230A-N in FIG. 2 illustrates such a joint probability distribution. For example, the joint probability distribution 230A includes an output label probability distribution 232A (which is a normalized probability distribution over the output label vocabulary of the transducer model 150) and an output label duration probability distribution 234A (which is a normalized probability distribution over the set of allowed durations for the transducer model 150). In the ASR embodiment described herein, each joint probability distribution of the joint probability distributions 230A-N can include a normalized probability distribution over a token vocabulary and a normalized probability distribution over a set of allowed durations of input audio frames.

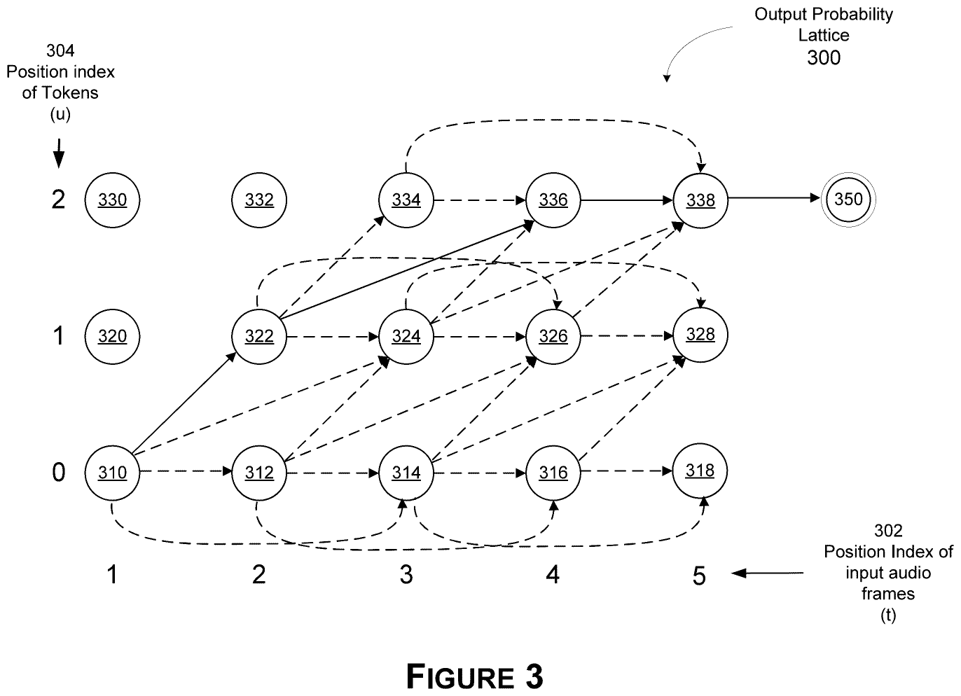

An output probability lattice 300 in FIG. 3 includes an illustration of some aspects of an example set of joint probability distributions 230A-N generated by the transducer model 150, where the set of allowed durations of the model is configured to include durations 1 and 2 only. In at least one embodiment, the output probability lattice 300 illustrates a subset of the probabilities in the set of joint probability distributions 230A-N and the subset of the probabilities is used to train the transducer model 150 (e.g., used to compute a loss function 242). As shown, the dimension 302 of the output probability lattice 300 (denoted by variable t) represents the position indices of inputs in an input sequence 202, according to the ASR embodiment described herein. Specifically, such position indices of inputs are position indices of audio frames in a sequence of audio frames in an audio signal. The domain of t is defined as 1≤t≤T, where T represents the number of audio frames in the audio signal. The dimension 304 of the output probability lattice 300 (denoted by variable u) represents the position indices of output labels in an output label sequence 204, according to the ASR embodiment described herein. Specifically, such position indices of output labels are position indices of tokens in a sequence of tokens. The domain of u is defined as 0≤u≤U, where U represents the number of tokens in the sequence of tokens.

As shown, given the dimensions t and u, each intersection of the two dimensions is illustrated as a node at location (t, u) (e.g., 310) in the output probability lattice 300. Each such node represents the probability of the first u tokens being emitted by the transducer model 150 in the first t input audio frames.

As shown, in some cases, a set of arrows originate from a node and end at other nodes in the output probability lattice 300. For example, four arrows originate from node 310 and end at nodes 322, 324, 312, and 314, respectively. Each of these arrows represents a possible transition away from node 310 and the collection of these arrows represent the possible transitions away from node 310 that are consistent with the configuration(s) of the transducer model 150 (e.g., the configuration that the set of allowed durations includes durations 1 and 2 only). Each given possible transition away from 310 is associated with a probability of the given possible transition occurring. Specifically, the possible transition from node 310 to node 312 is associated with a probability of the transducer model 150 emitting a blank token with a duration of 1 (or, in other words, by processing one input audio frame between t=1 and t=2). The possible transition from node 310 to node 314 is associated with a probability of the transducer model 150 emitting a blank token with a duration of 2 (or, in other words, by processing two input audio frames between t=1 and t=3). The possible transition from node 310 to node 322 is associated with a probability of the transducer model 150 emitting a non-blank token (at index 1) with a duration of 1 (or, in other words, by processing one input audio frame between t=1 and t=2). The possible transition from node 310 to node 324 is associated with a probability of the transducer model 150 emitting a non-blank token (at index 1) with a duration of 2 (or, in other words, by processing two input audio frames between t=1 and t=3).

These possible transitions' probabilities illustrate a subset of an example of a joint probability distribution in the set of joint probability distributions 230A-N in FIG. 2. As described herein, such a subset only includes probabilities that are consistent with the configuration(s) of the transducer model 150. Each such joint probability distribution in the set of joint probability distributions 230A-N can be formally denoted as P (v, d|t, u), which represents a probability of the transducer model 150 emitting a token “v” (which can be either a blank token or a non-blank token ‘Ø’), with duration d at a node located at (t, u).

Such a joint probability distribution assumes conditional independence between the probability distribution for tokens (which is an example of the output label probability distribution 232A in joint probability distribution 230A of FIG. 2) and the probability distribution for token durations (e.g., which is an example of the output label duration probability distribution 234A in joint probability distribution 230A of FIG. 2). Such conditional independence may be formally expressed in the following equation:

$$P ( v , d \vert t , u ) = PT ( v \vert t , u ) PD ( d \vert t , u ) \qquad ( 1 )$$

where PT (v|t, u) represents a probability distribution of the transducer model 150 emitting a token v at a node located at (t, u) and PD (d|t, u) represents a probability distribution of the token duration d for any token emitted by the transducer model 150 at a node located at (t, u).

As described herein, the output probability lattice 300 illustrates some aspects of the transducer model 150 that is configured to emit tokens with durations 1 and 2 only. Such a duration configuration means that each emission of a token v must process at least one input audio frame and up to two input audio frames in the dimension 302. Such a configuration disallows emitting tokens with duration 0 to prevent emitting the same token indefinitely, without processing any additional input audio frame(s) during inference. Such an undesirable behavior can occur due to that the joiner 222 is configured to generate outputs without the context of previously predicted tokens during inference, as described in FIG. 4, and thus is not disincentivized to predict the same token indefinitely. Thus, no arrows in the output probability lattice 300 transition from a node to other node(s) without processing at least one input audio frame in the dimension 302. For example, as shown, no arrows transition from node 310 to node 320 because such a transition would allow an emission of a token without processing an input audio frame. As a result, no arrows transition to node 330. Similarly, no arrows transition from node 322 to node 332. In such a manner, in at least one embodiment, joint probability distributions generated for nodes that are not reached by any transition probability arrow are not used to train the transducer model 150 (e.g., for computing the loss function 242). Collectively, all the sets of transition probability arrows originating from their respective nodes illustrated in the output probability lattice 300 represent an example subset of the probabilities in the set of joint probability distributions 230A-N in FIG. 2 that are used to train the transducer model 150. In some other embodiments, joint probability distributions generated for nodes not reached by any transition probability arrow are not generated by the transducer model 150 in the first place.

Returning to FIG. 2, if the transducer model 150 determines an occurrence of the second probabilistic event that the random mask 216 is applied, the joiner 222 generates a pair of outputs for each permutation of a position in the input sequence 202 and a position in the output sequence 204, as it does in the first probabilistic event above, based on the output of the encoder 212 and the masked output of the predictor 214 (instead of the regular output of the predictor 214). Given each such pair of outputs, the joiner 222 cause a joint probability distribution (e.g., the set of joint probability distributions 230A-N) to be generated, also as it does in the first probabilistic event above. However, because the regular output of the predictor 214 is masked, the operations of joiner 222 are performed effectively based solely on the output of the encoder 212. As will be discussed in more detail later with respect to FIG. 4, such a model training approach enables the transducer model 150 to operate non-autoregressively and more computationally efficient than a conventional transducer model during inference.

The masking operation can be applied at various suitable levels of granularity within training data. For example, in the ASR embodiment described herein, if the training of the transducer model 150 is performed in a batch mode, the masking operation can be performed at the batch level (typically at a sentence level). Specifically, given a sequence of input audio frames, the masking operation can be applied to the output of the predictor 214 that is generated based on the entire corresponding sentence. As another example, given a sequence of input audio frames, the masking operation can be applied to the output of the predictor 214 that is generated based on a given word in the corresponding sentence. In such a manner, each word of the sentence can be masked at random according to a given probability.

Given the set of joint probability distributions 230A-N, as the output of the transducer model 150, possible alignments between an input sequence 202 and an output label sequence 204 can be determined. For example, as shown in the output probability lattice 300 of FIG. 3, one possible alignment is illustrated as a complete path through the lattice that is formed by the solid arrows connecting nodes 310, 322, 336, and 338 before reaching the terminal node 350 of the lattice. Given the transition probabilities associated with the arrows forming such a path, the probability of the possible alignment represented by the path can be computed (e.g., by combining those probabilities). However, at this point of the training stage, the possible alignment (and other possible alignments) may not correspond to a satisfactory probability and thus may not represent a sufficiently accurate transformation from a given input sequence 202 to a given output sequence 204. Accordingly, the transducer model 150 is further refined to obtain more optimized possible alignments, e.g., using the loss function 242.

To compute a loss according to the loss function 242, the total probability PTDT(y|x) of an output label sequence 204 given an input sequence 202 for a transducer model 150 is computed, where y denotes a given output label sequence 204 and x denotes a given input sequence 202. PTDT(y|x) can be computed by summing the probabilities of the possible alignments between given output label sequence 204 that are consistent with the configuration(s) of the transducer model 150, given a given input sequence 202. In at least one embodiment, such computation is performed by computing a forward variable a and/or a backward variable B.

Illustrated using the output probability lattice 300 in FIG. 3 (and notations used in the lattice), a forward variable can be recursively defined using the following equation:

$$α ( t , u ) = {\sum }_{d ϵ D \backslash \{ 0 \}} α ( t - d , u ) P ( ∅ , d \vert t - d , u ) + {\sum }_{d ∈ D} α ( t - d , u - 1 ) P ( yu , d \vert t - d , u - 1 ) \qquad ( 2 )$$

where Ø denotes a blank output label (e.g., a blank token), yu denotes the output label with an index u, D denotes the set of allowed durations d, and the notation D\{0} denotes that 0 is excluded from D. In equation (2), the base condition α(1, 0)=1 is the same as the that of the forward variable's computation for a conventional transducer (“conventional forward variable computation”). However, equation (2) differs from the conventional forward variable computation in that, for both non-blank and blank token emissions, summing over durations in D is computed to consider all possible contributions from states that can reach (t, u), weighted by one or more corresponding duration probabilities. With the definition of a forward variable in equation (2), a total output probability PTDT(y|x) is computed through a at a terminal node (e.g., the terminal node 350 in the output probability lattice 300), e.g., using the following equation:

$$PTDT ( y \vert x ) = α ( T + 1 , U ) \qquad ( 3 )$$

A backward variable can be recursively defined using the following equation:

$$β ( t , u ) = {\sum }_{d ϵ D \backslash \{ 0 \}} β ( t + d , u ) P ( ∅ , d \vert t , u ) + {\sum }_{d ∈ D} β ( t + d , u + 1 ) P ( yu + 1 , d \vert t , u ) \qquad ( 4 )$$

where the base condition is β(T+1, U)=1, which is slightly different from a common definition used for a conventional transducer model but is equivalent to a standard definition. With this base condition notation, boundary case(s) for equation (4) can be computed more easily. For example, in a recursion, β(T+1, u)=α(T+1, u)=0, ∀u≠U. A total probability of a whole sequence is computed at the starting node (e.g., node 310 in the output probability lattice 300), e.g., using the following equation:

$$PTDT ( y \vert x ) = β ( 1 , 0 ) \qquad ( 5 )$$

Once the total probability PTDT(y|x) is computed based on computing a forward variable or a backward variable, loss can be computed according to the following equation:

$$LTDT = - log PTDT ( y \vert x ) \qquad ( 6 )$$

Once loss is computed, the gradient of the loss can be computed with respect to the configurations of the joiner 222, the encoder 212, and the predictor 214 (e.g., weights in the neutral networks that implement 222, 212, and 214). Specifically, in a first part, a gradient with respect to token probabilities [e.g., PT (v|t, u)] can be computed using the following equation:

$$\frac{\partial {L}_{TDT}}{\partial {P}_{T} ( v \vert t , u )} = - \frac{α ( t , u ) b ( v , t , u )}{{P}_{TDT} ( y \vert x )} \qquad ( 7 )$$

where α(t, u) is computed according to equation (2) above and b(v, t, u) is computed according to the following equation:

$$b ( v , t , u ) = \{ \begin{matrix}{\sum }_{d ϵ D} β ( t + d , u + 1 ) {P}_{D} ( d \vert t , u ) , v = {v}_{u + 1} \\ {\sum }_{d ϵ D} β ( t + d , u ) {P}_{D} ( d \vert t , u ) , v = ∅ \\ 0 , otherwise .\end{matrix} \qquad ( 8 )$$

where b(v, t, u) can be interpreted as a weighted sum of B's that are reachable from (t,u), with weights from a duration of probabilities.

In a second part, a gradient with respect to one or more duration probabilities [e.g., PD (v|t, u)] can be computed using the following equation:

$$\frac{\partial {L}_{TDT}}{\partial {P}_{D} ( d \vert t , u )} = - \frac{α ( t , u ) c ( d , t , u )}{P ( y \vert x )} \qquad ( 9 )$$

where c(d, t, u) is computed according to the following equation:

$$c ( d , t , u ) = \{ \begin{matrix}β ( t , u + 1 ) {P}_{T} ( {y}_{u + 1} \vert t , u ) , d = 0 \\ β ( t + d , u + 1 ) {P}_{T} ( {y}_{u + 1} \vert t , u ) + β ( t + d , u ) {P}_{T} ( ∅ \vert t , u ) d > 0\end{matrix} \qquad ( 10 )$$

In at least one embodiment, token probabilities [e.g., PT (v t, u)] are computed with a normalization function (e.g., a SoftMax function). Thus, a gradient with respect to token probabilities [e.g., PT (v t, u)] would need to go through the SoftMax function in order to be passed on to the previous layers of the neutral works that implement the joiner 222, the encoder 212, and the predictor 214. However, such a gradient computation is computational costly. One way to address this limitation can be to directly compute a gradient of the loss with respect to pre-softmax logits (e.g., a probability density function performed prior to the normalization of the dual output of the joiner 222, which is sometimes denoted as h^{v′}(t, u)). Such a computation of a gradient of the loss can defined according to the following equation:

$$\frac{\partial {L}_{TDT} ( y \vert x )}{\partial {h}^{v} ( t , u )} = \frac{{P}_{T} ( v \vert t , u ) α ( t , u ) [ β ( t , u ) - b ( v , t , u ) ]}{{P}_{TDT} ( y \vert x )} \qquad ( 11 )$$

In at least one embodiment, longer durations are encouraged during training, e.g., to maximize the computational efficiency that can be gained via longer durations during inference.

For example, PT (v|t, u) can be computed in a log domain, e.g., in order to have better numerical stability. Log probabilities [e.g., log PT (v|t, u)] can be computed from one or more logits [e.g., hv(t, u)] corresponding to token “v,” according to the following equation:

$$log {P}_{T} ( v \vert t , u ) = log soft {max}_{{v}^{′}} ( {h}^{{v}^{′}} ( t , u ) ) . \qquad ( 12 )$$

In such an embodiment, a pseudo probability [e.g., PT′ (v|t, u)] is used in forward variable and backward variable computations, which under-normalize logits, e.g., according to the following equation:

$$log {P}_{T}^{′} ( v \vert t , u ) = log soft {max}_{{v}^{′}} ( {h}^{{v}^{′}} ( t , u ) ) - σ . \qquad ( 13 )$$

It should be understood that the under-normalization technique above is only used in training. Gradients that incorporate a logit under-normalization method can be computed, e.g., according to the following equation:

$$\frac{\partial {L}_{TDT} ( y \vert x )}{\partial {h}^{v} ( t , u )} = \frac{{P}_{T} ( v \vert t , u ) α ( t , u ) [ β ( t , u ) - \frac{b ( v , t , u )}{exp ( σ )} ]}{exp [ {T}_{TDT} ( y \vert x ) ]} \qquad ( 14 )$$

where b(v, t, u) is computed according to equation (8) above. As shown, the equation (14) is similar to equation (11) with a difference being that a b(v, t, u) term is scaled by

$$\frac{1}{exp ( σ )} .$$

Once the gradient of the loss is computed, gradient descent can be performed. Specifically, the gradient is backpropagated through the transducer model 150, as illustrated in FIG. 2 as dotted arrows flowing from the loss function 242 to the joiner 222, and to the encoder 212 and the predictor 214. As described herein, in the second probabilistic event that the random mask 216 is applied to the output of the predictor 214, the output of the predictor 214 does not contribute to the loss computation and thus does not contribute to the gradient with respect to the predictor 214 (e.g., the contribution to the gradient is zero). In other words, in such cases, there is effectively no gradient with respect to the predictor 214 to be backpropagated.

FIG. 4 is an illustration of an example inference process using a transducer model 150 trained according to FIG. 2, according to various embodiments. As shown, such a process is performed in the sequence-to-sequence transformation application 146 of FIG. 1.

As described in FIG. 2 above, in the second probabilistic event that the random mask 216 is applied to the output of the predictor 214, a transducer model 150 is trained to transform a sequence of inputs to a sequence of outputs effectively without any input from the predictor 214 that correspond to a history of outputs predicted by the model. Thus, a transducer model 150 trained in this manner is able to operate in the same manner during inference. As such, the joiner 222 can be configured to receive no input from the predictor 214 during inference, as indicated by a cross-out symbol 410 in FIG. 4. Given an input sequence 402 (e.g., an input sequence like the input sequence 202 in FIG. 2), the encoder 212 processes the input sequence 402 as trained in the second probabilistic event of FIG. 2, where the input sequence 402 includes inputs 402A-N. Similarly, the joiner 222 processes the output of encoder 212 as trained in the second probabilistic event of FIG. 2. Because the joiner 222 does not depend on a history of outputs predicted by the transducer model 150, the joiner 222 processes the inputs 402A through 402N in parallel and causes the generation of joint probability distributions 430A through 430N, respectively, as trained in the second probabilistic event of FIG. 2. Each joint probability distribution of joint probability distributions 430A-N includes an output label probability distribution (e.g., 432A) and a corresponding output label duration probability distribution (e.g., 434A), like each of joint probability distributions 230A-N in FIG. 2. In such a manner, given the sequence of inputs in the input sequence 402, a corresponding sequence of joint probability distributions 430A-N is generated. Such a parallelized process of generating joint probability distributions 430A-N allows the transducer model 150 operate non-autoregressively and more computationally efficient than a conventional transducer model during inference.

Given the sequence of joint probability distributions 430A-N, the inference process causes a sequence of output labels 450 to be generated. Specifically, at least in one embodiment, for each joint probability distribution in the sequence of joint probability distributions 430A-N, the output label with the highest probability in the corresponding output label probability distribution (also referred to as a “highest-probability output label”) is used to create a first sequence of highest-probability output labels. In addition, for each such joint probability distribution, the output label duration with the highest probability in the corresponding output label duration probability distribution (also referred to as a “highest-probability output label duration”) is used to create a second sequence of highest-probability output label durations that corresponds to the sequence of highest-probability output labels.

Given each highest-probability output label in the first sequence, the inference process can determine the corresponding highest-probability output label duration in the corresponding second sequence. Given the determined highest-probability output label duration, the inference process skips ahead by the determined duration. Specifically, the inference process skips processing of a certain number of subsequent highest-probability output labels in the first sequence, where the certain number equals the determined duration. Such a skipping process repeats until all the highest-probability output labels in the first sequence are processed. As a result, a sequence of output labels 450 is created based on highest-probability output labels that have not been skipped. It should be understood that the predicted durations in the output label duration probability distributions allow such a skipping process and thus enables the inference process to be more computationally efficient than that of a conventional transducer model.

In such an embodiment, the inference process may further perform one or more operations to remove the blank output labels from the sequence of output labels 450 to create a sequence of non-blank output labels. In some other embodiments, such a sequence of non-blank output labels is created during the skipping process. Specifically, before skipping ahead, the inference process starts to create a sequence of non-blank output labels using a given highest-probability output label if that given output label is not a blank output label.

The following inference algorithm 1 illustrates an example implementation of the inference process described above with respect to the ASR embodiment described herein.

| | |
|---|---|
| 1: | input: acoustic input x |
| 2: | enc = encoder(x) |
| 3: | token-probs, duration-probs = joint(enc, decoder=None) |
| 4: | # now token-probs shape: [T, V], duration-probs shape: [T, D]. |
| 5: | tokens = argmax(token-probs,dim=−1) |
| 6: | durations = argmax(duration-probs,dim=−1) |
| 7: | hyp = [ ]; t = 0 |
| 8: | while t < len(enc) do |
| 9: | token = tokens[t] |
| 10: | if token is not blank then |
| 11: | hyp.append(token) |
| 12: | t += durations[t] |
| 13: | return hyp |

where, among other things, an encoder function denotes an encoder (e.g., the encoder 212); a decoder function denotes a predictor (e.g., the predictor 214); a joint function denotes a joiner (e.g., the joiner 222); token-probs and duration-probs denote output label probability distributions (e.g., 432A-N) and output label duration probability distributions (e.g., 434A-N), respectively; and hyp denotes a sequence of non-blank output labels. In addition, “decoder-None” denotes that the joint function is configured to receive no input from the decoder function.

As also described in FIG. 2 above, in the first probabilistic event that the random mask 216 is not applied to the output of the predictor 214, a transducer model 150 is also trained to transform a sequence of inputs to a sequence of outputs using the output of the encoder 212 and output of the predictor 214, which is based on a history of outputs predicted by the model. Thus, a transducer model 150 trained in this manner is able to operate in the same manner during inference. As such, the joiner 222 can be configured to receive input from the encoder 212 and the predictor 214 during inference (not shown in FIG. 4). Because a transducer model 150 configured in such a manner generates its output(s) based on a history of predicted outputs, the model is capable of generating outputs with more accuracy than the NAR models described herein. The following inference algorithm 2 illustrates an example implementation of such an inference process with respect to the ASR embodiment described herein, where algorithm 2 implements the greedy search algorithm.

| | |
|---|---|
| 1: | input: acoustic input x |
| 2: | enc = encoder(x) |
| 3: | hyp = [ ] |
| 4: | t = 0 |
| 5: | while t < len(enc) do |
| 6: | dec = decoder(hyp) |
| 7: | joined = joint(enc[t], dec) |
| 8: | idx = argmax(joined[:vocab size]) |
| 9: | duration_idx = argmax(joined[vocab size:]) |
| 10: | if token is not blank then |
| 11: | hyp.append(idx2token[idx]) |
| 12: | end if |
| 13: | t += duration_idx2duration[duration idx] |
| 14: | end while |
| 15: | return hyp |

where, among other things, encoder denotes an encoder (e.g., the encoder 212); decoder denotes a predictor (e.g., the predictor 214); joint denotes a joiner (e.g., the joiner 222); joined [: vocab size] and joined [vocab size:] denote output label probability distributions (e.g., 432A-N) and output label duration probability distributions (e.g., 434A-N), respectively; hyp denotes a sequence of historical non-blank output labels emitted by the transducer model 150; and duration_idx2duration denotes a function that outputs a predicted duration that corresponds to a predicted token (denoted as idx2token[idx]). As shown, a predicted duration is used to increment t (e.g., to skip processing input audio frames). As also shown, “decoder (hyp)” denotes that a sequence of historical non-blank output labels are used by the decoder function to predict a next token.

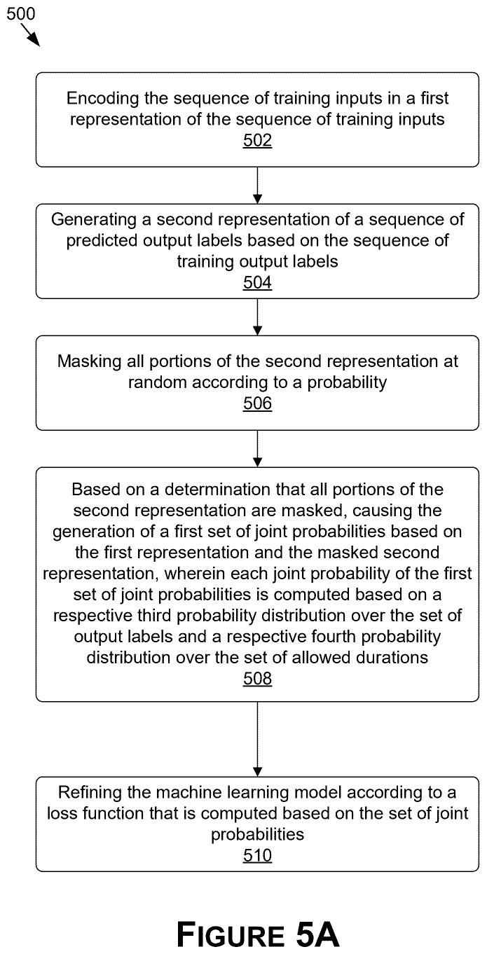

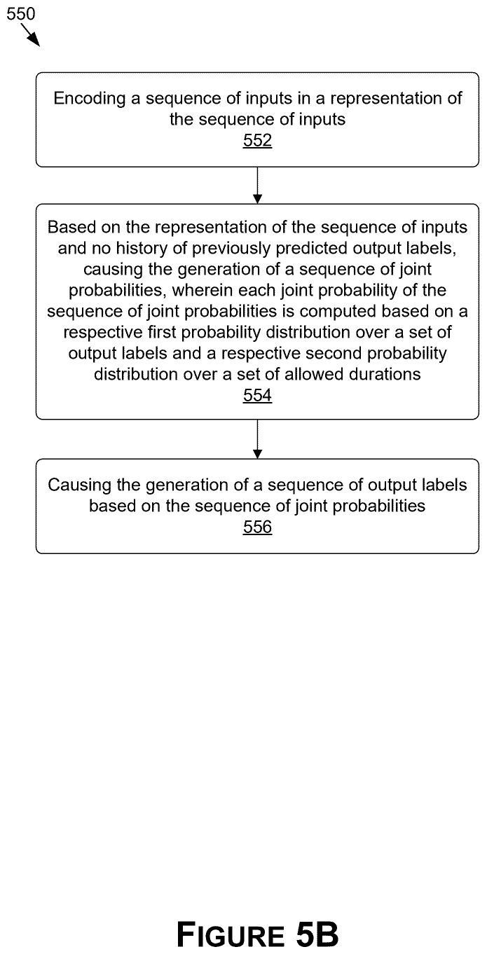

Now referring to FIGS. 5A-B, each block of methods 500 and 550, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 500 and 550 are described, by way of example, with respect to the system of FIG. 1. However, these methods may additionally or alternatively be executed by any one system, or any combination of systems, including, but not limited to, those described herein.

FIG. 5A is a flow diagram showing a method 500 for FIG. 2, according to various embodiments. The method 500 trains of the transducer model 150 of FIG. 1. As shown in FIG. 5A, method 500 begins with operation 502, in which a model trainer (e.g., the model trainer 116) performs one or more operations for each sequence of training inputs and a corresponding sequence of training output labels. Specifically, at operation 502, the model trainer encodes the sequence of training inputs in a first representation of the sequence of training inputs. At operation 504, the model trainer generates a second representation of a sequence of predicted output labels based on the sequence of training output labels. At operation 506, the model trainer masks all portions of the second representation at random according to a probability. At operation 508, the model trainer causes the generation of a first set of joint probabilities based on the first representation and the masked second representation based on a determination that portions (e.g., all portions) of the second representation are masked. Each joint probability of the first set of joint probabilities is computed based on a respective third probability distribution over the set of output labels and a respective fourth probability distribution over the set of allowed durations. In some embodiments, based on a determination that no portions of the second representation are masked, the model trainer causes the generation of a second set of joint probabilities based on the first representation and the second representation. In such embodiments, each joint probability of the second set of joint probabilities is computed based on a respective fifth probability distribution over the set of output labels and a respective sixth probability distribution over the set of allowed durations. At operation 510, the model trainer refines the machine learning model according to a loss function that is computed based on the set of joint probabilities.

FIG. 5B is a flow diagram showing a method 550 for FIG. 4, according to various embodiments. The method 550 performs inference using the trained transducer model 150 of FIG. 2. As shown in FIG. 5B, method 550 begins with operation 552, in which a sequence-to-sequence transformation application (e.g., the sequence-to-sequence transformation application 146) encodes a sequence of inputs in a representation of the sequence of inputs. In some embodiments, the sequence of inputs includes a sequence of audio frames, and the sequence of outputs includes a sequence of text. In some embodiments, each allowed duration of the set of allowed durations indicates a possible number of inputs that are allowed to be processed to generate an output label.

At operation 554, the sequence-to-sequence transformation application causes the generation of a sequence of joint probabilities based on the representation of the sequence of inputs and no history of previously predicted output labels. Each joint probability of the sequence of joint probabilities is computed based on a respective first probability distribution over a set of output labels and a respective second probability distribution over a set of allowed durations.

At operation 556, the sequence-to-sequence transformation application causes the generation of a sequence of output labels based on the sequence of joint probabilities.

In some embodiments, the model trainer receives the sequence of inputs. In some embodiments, the model trainer updates the sequence of output labels by removing blank output labels from the sequence of output labels.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Autonomous Vehicle

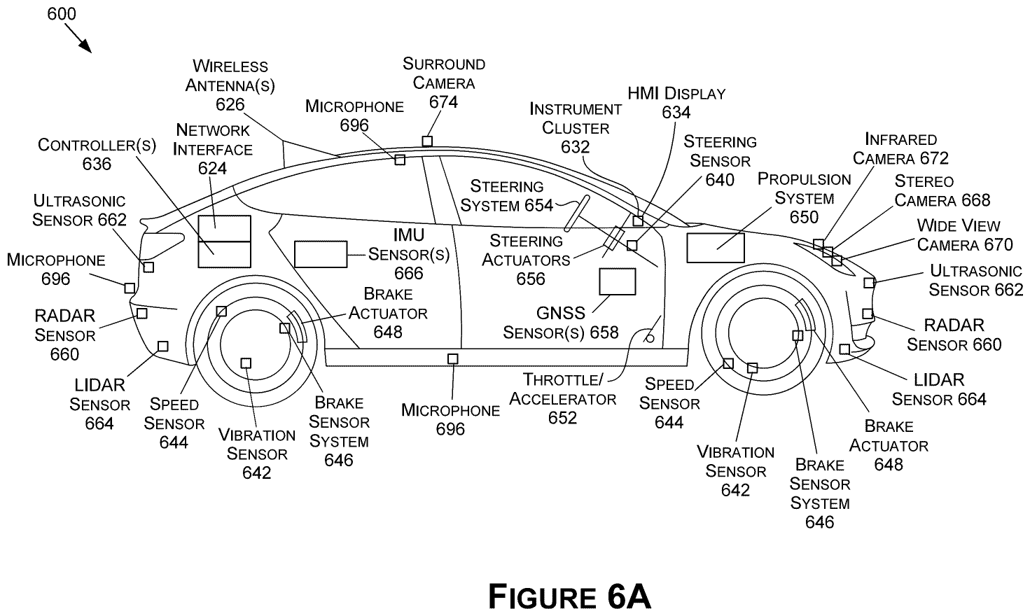

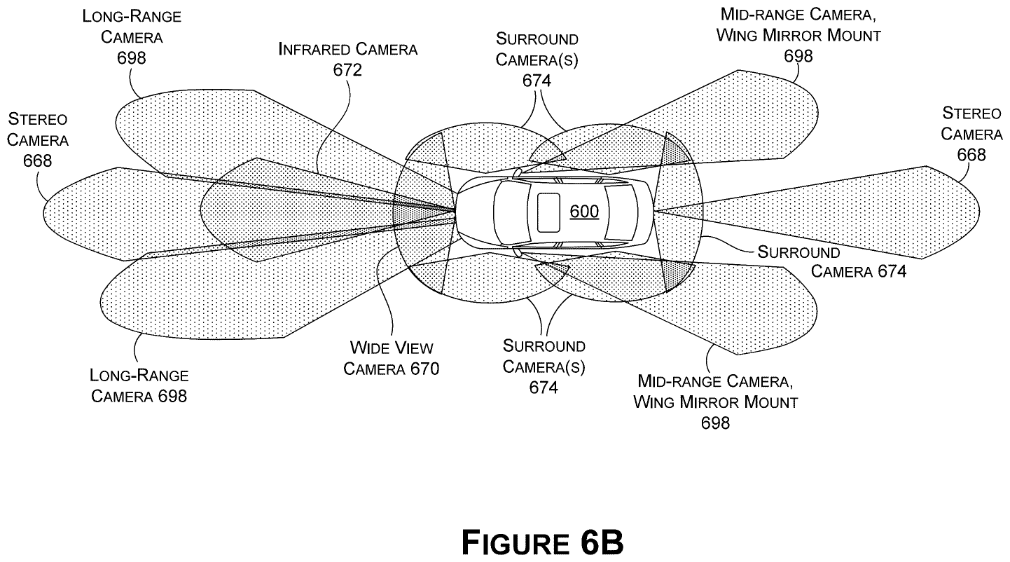

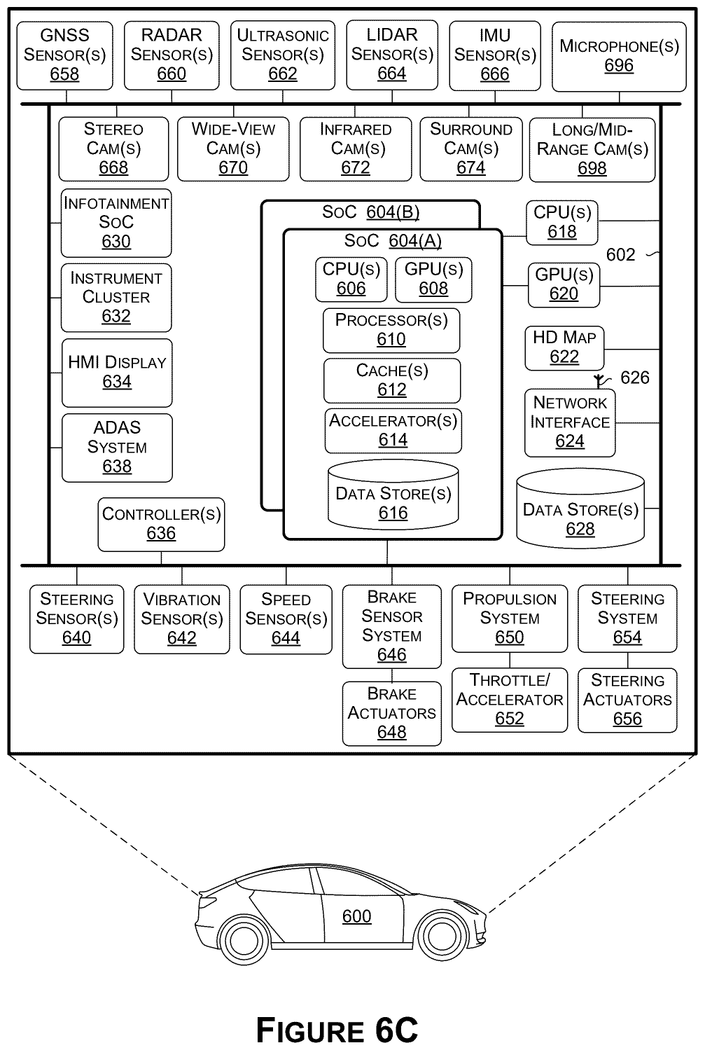

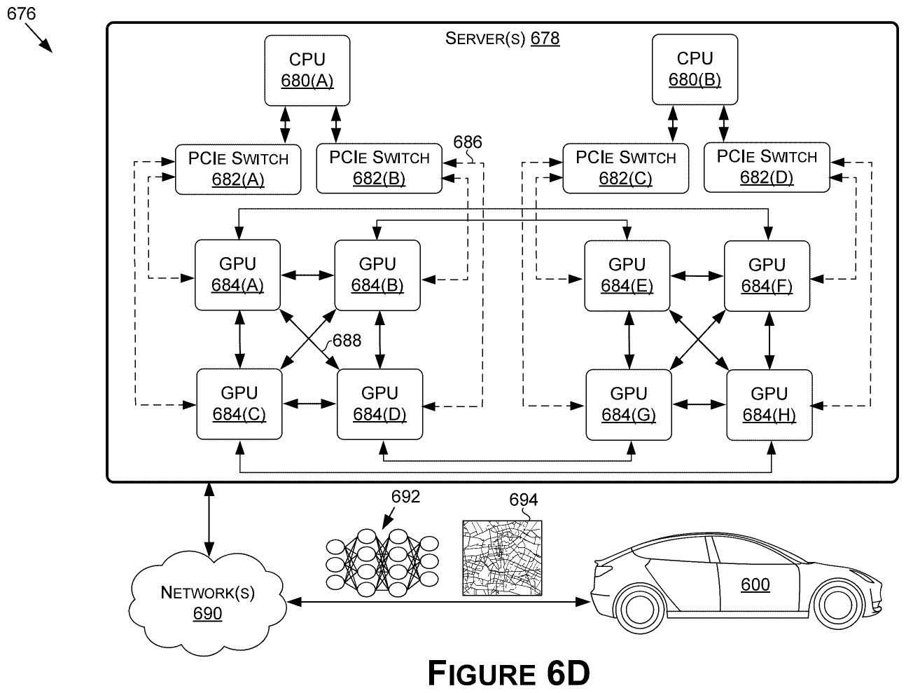

FIG. 6A is an illustration of an example autonomous vehicle 600, in accordance with some embodiments of the present disclosure. The autonomous vehicle 600 (alternatively referred to herein as the “vehicle 600”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 600 may be capable of functionality in accordance with one or more of Level 3-Level 5 of the autonomous driving levels. The vehicle 600 may be capable of functionality in accordance with one or more of Level 1-Level 5 of the autonomous driving levels. For example, the vehicle 600 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 600 or other machine, such as being fully autonomous, being highly autonomous, being conditionally autonomous, being partially autonomous, providing assistive autonomy, being semi-autonomous, being primarily autonomous, or other designation.

The vehicle 600 may include components such as a chassis, a vehicle body, wheels (e.g., 2, 4, 6, 8, 18, etc.), tires, axles, and other components of a vehicle. The vehicle 600 may include a propulsion system 650, such as an internal combustion engine, hybrid electric power plant, an all-electric engine, and/or another propulsion system type. The propulsion system 650 may be connected to a drive train of the vehicle 600, which may include a transmission, to enable the propulsion of the vehicle 600. The propulsion system 650 may be controlled in response to receiving signals from the throttle/accelerator 652.

A steering system 654, which may include a steering wheel, may be used to steer the vehicle 600 (e.g., along a desired path or route) when the propulsion system 650 is operating (e.g., when the vehicle is in motion). The steering system 654 may receive signals from a steering actuator 656. The steering wheel may be optional for full automation (Level 5) functionality.

The brake sensor system 646 may be used to operate the vehicle brakes in response to receiving signals from the brake actuators 648 and/or brake sensors.

Controller(s) 636, which may include one or more system on chips (SoCs) 604 (FIG. 6C) and/or GPU(s), may provide signals (e.g., representative of commands) to one or more components and/or systems of the vehicle 600. For example, the controller(s) may send signals to operate the vehicle brakes via one or more brake actuators 648, to operate the steering system 654 via one or more steering actuators 656, to operate the propulsion system 650 via one or more throttle/accelerators 652. The controller(s) 636 may include one or more onboard (e.g., integrated) computing devices (e.g., supercomputers) that process sensor signals, and output operation commands (e.g., signals representing commands) to enable autonomous driving and/or to assist a human driver in driving the vehicle 600. The controller(s) 636 may include a first controller 636 for autonomous driving functions, a second controller 636 for functional safety functions, a third controller 636 for artificial intelligence functionality (e.g., computer vision), a fourth controller 636 for infotainment functionality, a fifth controller 636 for redundancy in emergency conditions, and/or other controllers. In some examples, a single controller 636 may handle two or more of the above functionalities, two or more controllers 636 may handle a single functionality, and/or any combination thereof.

The controller(s) 636 may provide the signals for controlling one or more components and/or systems of the vehicle 600 in response to sensor data received from one or more sensors (e.g., sensor inputs). The sensor data may be received from, for example and without limitation, global navigation satellite systems (“GNSS”) sensor(s) 658 (e.g., Global Positioning System sensor(s)), RADAR sensor(s) 660, ultrasonic sensor(s) 662, LIDAR sensor(s) 664, inertial measurement unit (IMU) sensor(s) 666 (e.g., accelerometer(s), gyroscope(s), magnetic compass(es), magnetometer(s), etc.), microphone(s) 696, stereo camera(s) 668, wide-view camera(s) 670 (e.g., fisheye cameras), infrared camera(s) 672, surround camera(s) 674 (e.g., 360 degree cameras), long-range and/or mid-range camera(s) 698, speed sensor(s) 644 (e.g., for measuring the speed of the vehicle 600), vibration sensor(s) 642, steering sensor(s) 640, brake sensor(s) (e.g., as part of the brake sensor system 646), and/or other sensor types.

One or more of the controller(s) 636 may receive inputs (e.g., represented by input data) from an instrument cluster 632 of the vehicle 600 and provide outputs (e.g., represented by output data, display data, etc.) via a human-machine interface (HMI) display 634, an audible annunciator, a loudspeaker, and/or via other components of the vehicle 600. The outputs may include information such as vehicle velocity, speed, time, map data (e.g., the High Definition (“HD”) map 622 of FIG. 6C), location data (e.g., the vehicle's 600 location, such as on a map), direction, location of other vehicles (e.g., an occupancy grid), information about objects and status of objects as perceived by the controller(s) 636, etc. For example, the HMI display 634 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 600 further includes a network interface 624 which may use one or more wireless antenna(s) 626 and/or modem(s) to communicate over one or more networks. For example, the network interface 624 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 626 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 6B is an example of camera locations and fields of view for the example autonomous vehicle 600 of FIG. 6A, in accordance with some embodiments of the present disclosure. The cameras and respective fields of view are one example embodiment and are not intended to be limiting. For example, additional and/or alternative cameras may be included and/or the cameras may be located at different locations on the vehicle 600.

The camera types for the cameras may include, but are not limited to, digital cameras that may be adapted for use with the components and/or systems of the vehicle 600. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 600 (e.g., front-facing cameras) may be used for surround view, to help identify forward facing paths and obstacles, as well aid in, with the help of one or more controllers 636 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 670 that may be used to perceive objects coming into view from the periphery (e.g., pedestrians, crossing traffic or bicycles). Although only one wide-view camera is illustrated in FIG. 6B, there may be any number (including zero) of wide-view cameras 670 on the vehicle 600. In addition, any number of long-range camera(s) 698 (e.g., a long-view stereo camera pair) may be used for depth-based object detection, especially for objects for which a neural network has not yet been trained. The long-range camera(s) 698 may also be used for object detection and classification, as well as basic object tracking.

Any number of stereo cameras 668 may also be included in a front-facing configuration. In at least one embodiment, one or more of stereo camera(s) 668 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 668 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 668 may be used in addition to, or alternatively from, those described herein.

Cameras with a field of view that include portions of the environment to the side of the vehicle 600 (e.g., side-view cameras) may be used for surround view, providing information used to create and update the occupancy grid, as well as to generate side impact collision warnings. For example, surround camera(s) 674 (e.g., four surround cameras 674 as illustrated in FIG. 6B) may be positioned to on the vehicle 600. The surround camera(s) 674 may include wide-view camera(s) 670, fisheye camera(s), 360 degree camera(s), and/or the like. Four example, four fisheye cameras may be positioned on the vehicle's front, rear, and sides. In an alternative arrangement, the vehicle may use three surround camera(s) 674 (e.g., left, right, and rear), and may leverage one or more other camera(s) (e.g., a forward-facing camera) as a fourth surround view camera.

Cameras with a field of view that include portions of the environment to the rear of the vehicle 600 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 698, stereo camera(s) 668), infrared camera(s) 672, etc.), as described herein.

FIG. 6C is a block diagram of an example system architecture for the example autonomous vehicle 600 of FIG. 6A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 600 in FIG. 6C are illustrated as being connected via bus 602. The bus 602 may include a Controller Area Network (CAN) data interface (alternatively referred to herein as a “CAN bus”). A CAN may be a network inside the vehicle 600 used to aid in control of various features and functionality of the vehicle 600, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 602 is described herein as being a CAN bus, this is not intended to be limiting. For example, in addition to, or alternatively from, the CAN bus, FlexRay and/or Ethernet may be used. Additionally, although a single line is used to represent the bus 602, this is not intended to be limiting. For example, there may be any number of busses 602, which may include one or more CAN busses, one or more FlexRay busses, one or more Ethernet busses, and/or one or more other types of busses using a different protocol. In some examples, two or more busses 602 may be used to perform different functions, and/or may be used for redundancy. For example, a first bus 602 may be used for collision avoidance functionality and a second bus 602 may be used for actuation control. In any example, each bus 602 may communicate with any of the components of the vehicle 600, and two or more busses 602 may communicate with the same components. In some examples, each SoC 604, each controller 636, and/or each computer within the vehicle may have access to the same input data (e.g., inputs from sensors of the vehicle 600), and may be connected to a common bus, such the CAN bus.

The vehicle 600 may include one or more controller(s) 636, such as those described herein with respect to FIG. 6A. The controller(s) 636 may be used for a variety of functions. The controller(s) 636 may be coupled to any of the various other components and systems of the vehicle 600, and may be used for control of the vehicle 600, artificial intelligence of the vehicle 600, infotainment for the vehicle 600, and/or the like.

The vehicle 600 may include a system(s) on a chip (SoC) 604. The SoC 604 may include CPU(s) 606, GPU(s) 608, processor(s) 610, cache(s) 612, accelerator(s) 614, data store(s) 616, and/or other components and features not illustrated. The SoC(s) 604 may be used to control the vehicle 600 in a variety of platforms and systems. For example, the SoC(s) 604 may be combined in a system (e.g., the system of the vehicle 600) with an HD map 622 which may obtain map refreshes and/or updates via a network interface 624 from one or more servers (e.g., server(s) 678 of FIG. 6D).

The CPU(s) 606 may include a CPU cluster or CPU complex (alternatively referred to herein as a “CCPLEX”). The CPU(s) 606 may include multiple cores and/or L2 caches. For example, in some embodiments, the CPU(s) 606 may include eight cores in a coherent multi-processor configuration. In some embodiments, the CPU(s) 606 may include four dual-core clusters where each cluster has a dedicated L2 cache (e.g., a 2 MB L2 cache). The CPU(s) 606 (e.g., the CCPLEX) may be configured to support simultaneous cluster operation enabling any combination of the clusters of the CPU(s) 606 to be active at any given time.

The CPU(s) 606 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 606 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 608 may include an integrated GPU (alternatively referred to herein as an “iGPU”). The GPU(s) 608 may be programmable and may be efficient for parallel workloads. The GPU(s) 608, in some examples, may use an enhanced tensor instruction set. The GPU(s) 608 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 608 may include at least eight streaming microprocessors. The GPU(s) 608 may use compute application programming interface(s) (API(s)). In addition, the GPU(s) 608 may use one or more parallel computing platforms and/or programming models (e.g., NVIDIA's CUDA).

The GPU(s) 608 may be power-optimized for best performance in automotive and embedded use cases. For example, the GPU(s) 608 may be fabricated on a Fin field-effect transistor (FinFET). However, this is not intended to be limiting and the GPU(s) 608 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 608 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 608 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 608 to access the CPU(s) 606 page tables directly. In such examples, when the GPU(s) 608 memory management unit (MMU) experiences a miss, an address translation request may be transmitted to the CPU(s) 606. In response, the CPU(s) 606 may look in its page tables for the virtual-to-physical mapping for the address and transmits the translation back to the GPU(s) 608. As such, unified memory technology may allow a single unified virtual address space for memory of both the CPU(s) 606 and the GPU(s) 608, thereby simplifying the GPU(s) 608 programming and porting of applications to the GPU(s) 608.

In addition, the GPU(s) 608 may include an access counter that may keep track of the frequency of access of the GPU(s) 608 to memory of other processors. The access counter may help ensure that memory pages are moved to the physical memory of the processor that is accessing the pages most frequently.

The SoC(s) 604 may include any number of cache(s) 612, including those described herein. For example, the cache(s) 612 may include an L3 cache that is available to both the CPU(s) 606 and the GPU(s) 608 (e.g., that is connected both the CPU(s) 606 and the GPU(s) 608). The cache(s) 612 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 604 may include an arithmetic logic unit(s) (ALU(s)) which may be leveraged in performing processing with respect to any of the variety of tasks or operations of the vehicle 600—such as processing DNNs. In addition, the SoC(s) 604 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 606 and/or GPU(s) 608.

The SoC(s) 604 may include one or more accelerators 614 (e.g., hardware accelerators, software accelerators, or a combination thereof). For example, the SoC(s) 604 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 608 and to off-load some of the tasks of the GPU(s) 608 (e.g., to free up more cycles of the GPU(s) 608 for performing other tasks). As an example, the accelerator(s) 614 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 614 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 608, and by using an inference accelerator, for example, a designer may target either the DLA(s) or the GPU(s) 608 for any function. For example, the designer may focus processing of CNNs and floating point operations on the DLA(s) and leave other functions to the GPU(s) 608 and/or other accelerator(s) 614.

The accelerator(s) 614 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 606. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 614 (e.g., the hardware acceleration cluster) may include a computer vision network on-chip and SRAM, for providing a high-bandwidth, low latency SRAM for the accelerator(s) 614. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 604 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 614 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 666 output that correlates with the vehicle 600 orientation, distance, 3D location estimates of the object obtained from the neural network and/or other sensors (e.g., LIDAR sensor(s) 664 or RADAR sensor(s) 660), among others.

The SoC(s) 604 may include data store(s) 616 (e.g., memory). The data store(s) 616 may be on-chip memory of the SoC(s) 604, which may store neural networks to be executed on the GPU and/or the DLA. In some examples, the data store(s) 616 may be large enough in capacity to store multiple instances of neural networks for redundancy and safety. The data store(s) 612 may comprise L2 or L3 cache(s) 612. Reference to the data store(s) 616 may include reference to the memory associated with the PVA, DLA, and/or other accelerator(s) 614, as described herein.

The SoC(s) 604 may include one or more processor(s) 610 (e.g., embedded processors). The processor(s) 610 may include a boot and power management processor that may be a dedicated processor and subsystem to handle boot power and management functions and related security enforcement. The boot and power management processor may be a part of the SoC(s) 604 boot sequence and may provide runtime power management services. The boot power and management processor may provide clock and voltage programming, assistance in system low power state transitions, management of SoC(s) 604 thermals and temperature sensors, and/or management of the SoC(s) 604 power states. Each temperature sensor may be implemented as a ring-oscillator whose output frequency is proportional to temperature, and the SoC(s) 604 may use the ring-oscillators to detect temperatures of the CPU(s) 606, GPU(s) 608, and/or accelerator(s) 614. If temperatures are determined to exceed a threshold, the boot and power management processor may enter a temperature fault routine and put the SoC(s) 604 into a lower power state and/or put the vehicle 600 into a chauffeur to safe stop mode (e.g., bring the vehicle 600 to a safe stop).

The processor(s) 610 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 610 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 610 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 610 may further include a real-time camera engine that may include a dedicated processor subsystem for handling real-time camera management.

The processor(s) 610 may further include a high-dynamic range signal processor that may include an image signal processor that is a hardware engine that is part of the camera processing pipeline.

The processor(s) 610 may include a video image compositor that may be a processing block (e.g., implemented on a microprocessor) that implements video post-processing functions needed by a video playback application to produce the final image for the player window. The video image compositor may perform lens distortion correction on wide-view camera(s) 670, surround camera(s) 674, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 608 is not required to continuously render new surfaces. Even when the GPU(s) 608 is powered on and active doing 3D rendering, the video image compositor may be used to offload the GPU(s) 608 to improve performance and responsiveness.

The SoC(s) 604 may further include a mobile industry processor interface (MIPI) camera serial interface for receiving video and input from cameras, a high-speed interface, and/or a video input block that may be used for camera and related pixel input functions. The SoC(s) 604 may further include an input/output controller(s) that may be controlled by software and may be used for receiving I/O signals that are uncommitted to a specific role.

The SoC(s) 604 may further include a broad range of peripheral interfaces to enable communication with peripherals, audio codecs, power management, and/or other devices. The SoC(s) 604 may be used to process data from cameras (e.g., connected over Gigabit Multimedia Serial Link and Ethernet), sensors (e.g., LIDAR sensor(s) 664, RADAR sensor(s) 660, etc. that may be connected over Ethernet), data from bus 602 (e.g., speed of vehicle 600, steering wheel position, etc.), data from GNSS sensor(s) 658 (e.g., connected over Ethernet or CAN bus). The SoC(s) 604 may further include dedicated high-performance mass storage controllers that may include their own DMA engines, and that may be used to free the CPU(s) 606 from routine data management tasks.

The SoC(s) 604 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 604 may be faster, more reliable, and even more energy-efficient and space-efficient than conventional systems. For example, the accelerator(s) 614, when combined with the CPU(s) 606, the GPU(s) 608, and the data store(s) 616, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 620) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 608.

In some examples, a CNN for facial recognition and vehicle owner identification may use data from camera sensors to identify the presence of an authorized driver and/or owner of the vehicle 600. The always on sensor processing engine may be used to unlock the vehicle when the owner approaches the driver door and turn on the lights, and, in security mode, to disable the vehicle when the owner leaves the vehicle. In this way, the SoC(s) 604 provide for security against theft and/or carjacking.

In another example, a CNN for emergency vehicle detection and identification may use data from microphones 696 to detect and identify emergency vehicle sirens. In contrast to conventional systems, that use general classifiers to detect sirens and manually extract features, the SoC(s) 604 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 658. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 662, until the emergency vehicle(s) passes.

The vehicle may include a CPU(s) 618 (e.g., discrete CPU(s), or dCPU(s)), that may be coupled to the SoC(s) 604 via a high-speed interconnect (e.g., PCIe). The CPU(s) 618 may include an X86 processor, for example. The CPU(s) 618 may be used to perform any of a variety of functions, including arbitrating potentially inconsistent results between ADAS sensors and the SoC(s) 604, and/or monitoring the status and health of the controller(s) 636 and/or infotainment SoC 630, for example.

The vehicle 600 may include a GPU(s) 620 (e.g., discrete GPU(s), or dGPU(s)), that may be coupled to the SoC(s) 604 via a high-speed interconnect (e.g., NVIDIA's NVLINK). The GPU(s) 620 may provide additional artificial intelligence functionality, such as by executing redundant and/or different neural networks, and may be used to train and/or update neural networks based on input (e.g., sensor data) from sensors of the vehicle 600.

The vehicle 600 may further include the network interface 624 which may include one or more wireless antennas 626 (e.g., one or more wireless antennas for different communication protocols, such as a cellular antenna, a Bluetooth antenna, etc.). The network interface 624 may be used to enable wireless connectivity over the Internet with the cloud (e.g., with the server(s) 678 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 600 information about vehicles in proximity to the vehicle 600 (e.g., vehicles in front of, on the side of, and/or behind the vehicle 600). This functionality may be part of a cooperative adaptive cruise control functionality of the vehicle 600.

The network interface 624 may include a SoC that provides modulation and demodulation functionality and enables the controller(s) 636 to communicate over wireless networks. The network interface 624 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 600 may further include data store(s) 628 which may include off-chip (e.g., off the SoC(s) 604) storage. The data store(s) 628 may include one or more storage elements including RAM, SRAM, DRAM, VRAM, Flash, hard disks, and/or other components and/or devices that may store at least one bit of data.

The vehicle 600 may further include GNSS sensor(s) 658. The GNSS sensor(s) 658 (e.g., GPS, assisted GPS sensors, differential GPS (DGPS) sensors, etc.), to assist in mapping, perception, occupancy grid generation, and/or path planning functions. Any number of GNSS sensor(s) 658 may be used, including, for example and without limitation, a GPS using a USB connector with an Ethernet to Serial (RS-232) bridge.

The vehicle 600 may further include RADAR sensor(s) 660. The RADAR sensor(s) 660 may be used by the vehicle 600 for long-range vehicle detection, even in darkness and/or severe weather conditions. RADAR functional safety levels may be ASIL B. The RADAR sensor(s) 660 may use the CAN and/or the bus 602 (e.g., to transmit data generated by the RADAR sensor(s) 660) for control and to access object tracking data, with access to Ethernet to access raw data in some examples. A wide variety of RADAR sensor types may be used. For example, and without limitation, the RADAR sensor(s) 660 may be suitable for front, rear, and side RADAR use. In some example, Pulse Doppler RADAR sensor(s) are used.

The RADAR sensor(s) 660 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 660 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 600 surroundings at higher speeds with minimal interference from traffic in adjacent lanes. The other two antennae may expand the field of view, making it possible to quickly detect vehicles entering or leaving the vehicle's 600 lane.

Mid-range RADAR systems may include, as an example, a range of up to 660 m (front) or 80 m (rear), and a field of view of up to 42 degrees (front) or 650 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 600 may further include ultrasonic sensor(s) 662. The ultrasonic sensor(s) 662, which may be positioned at the front, back, and/or the sides of the vehicle 600, may be used for park assist and/or to create and update an occupancy grid. A wide variety of ultrasonic sensor(s) 662 may be used, and different ultrasonic sensor(s) 662 may be used for different ranges of detection (e.g., 2.5 m, 4 m). The ultrasonic sensor(s) 662 may operate at functional safety levels of ASIL B.

The vehicle 600 may include LIDAR sensor(s) 664. The LIDAR sensor(s) 664 may be used for object and pedestrian detection, emergency braking, collision avoidance, and/or other functions. The LIDAR sensor(s) 664 may be functional safety level ASIL B. In some examples, the vehicle 600 may include multiple LIDAR sensors 664 (e.g., two, four, six, etc.) that may use Ethernet (e.g., to provide data to a Gigabit Ethernet switch).

In some examples, the LIDAR sensor(s) 664 may be capable of providing a list of objects and their distances for a 360-degree field of view. Commercially available LIDAR sensor(s) 664 may have an advertised range of approximately 600 m, with an accuracy of 2 cm-3 cm, and with support for a 600 Mbps Ethernet connection, for example. In some examples, one or more non-protruding LIDAR sensors 664 may be used. In such examples, the LIDAR sensor(s) 664 may be implemented as a small device that may be embedded into the front, rear, sides, and/or corners of the vehicle 600. The LIDAR sensor(s) 664, in such examples, may provide up to a 120-degree horizontal and 35-degree vertical field-of-view, with a 200 m range even for low-reflectivity objects. Front-mounted LIDAR sensor(s) 664 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 600. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 664 may be less susceptible to motion blur, vibration, and/or shock.

The vehicle may further include IMU sensor(s) 666. The IMU sensor(s) 666 may be located at a center of the rear axle of the vehicle 600, in some examples. The IMU sensor(s) 666 may include, for example and without limitation, an accelerometer(s), a magnetometer(s), a gyroscope(s), a magnetic compass(es), and/or other sensor types. In some examples, such as in six-axis applications, the IMU sensor(s) 666 may include accelerometers and gyroscopes, while in nine-axis applications, the IMU sensor(s) 666 may include accelerometers, gyroscopes, and magnetometers.

In some embodiments, the IMU sensor(s) 666 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 666 may enable the vehicle 600 to estimate heading without requiring input from a magnetic sensor by directly observing and correlating the changes in velocity from GPS to the IMU sensor(s) 666. In some examples, the IMU sensor(s) 666 and the GNSS sensor(s) 658 may be combined in a single integrated unit.

The vehicle may include microphone(s) 696 placed in and/or around the vehicle 600. The microphone(s) 696 may be used for emergency vehicle detection and identification, among other things.

The vehicle may further include any number of camera types, including stereo camera(s) 668, wide-view camera(s) 670, infrared camera(s) 672, surround camera(s) 674, long-range and/or mid-range camera(s) 698, and/or other camera types. The cameras may be used to capture image data around an entire periphery of the vehicle 600. The types of cameras used depends on the embodiments and requirements for the vehicle 600, and any combination of camera types may be used to provide the necessary coverage around the vehicle 600. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 6A and FIG. 6B.

The vehicle 600 may further include vibration sensor(s) 642. The vibration sensor(s) 642 may measure vibrations of components of the vehicle, such as the axle(s). For example, changes in vibrations may indicate a change in road surfaces. In another example, when two or more vibration sensors 642 are used, the differences between the vibrations may be used to determine friction or slippage of the road surface (e.g., when the difference in vibration is between a power-driven axle and a freely rotating axle).

The vehicle 600 may include an ADAS system 638. The ADAS system 638 may include a SoC, in some examples. The ADAS system 638 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 660, LIDAR sensor(s) 664, and/or a camera(s). The ACC systems may include longitudinal ACC and/or lateral ACC. Longitudinal ACC monitors and controls the distance to the vehicle immediately ahead of the vehicle 600 and automatically adjust the vehicle speed to maintain a safe distance from vehicles ahead. Lateral ACC performs distance keeping, and advises the vehicle 600 to change lanes when necessary. Lateral ACC is related to other ADAS applications such as LCA and CWS.

CACC uses information from other vehicles that may be received via the network interface 624 and/or the wireless antenna(s) 626 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 600), while the I2V communication concept provides information about traffic further ahead. CACC systems may include either or both I2V and V2V information sources. Given the information of the vehicles ahead of the vehicle 600, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 660, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 660, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 600 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 600 if the vehicle 600 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 660, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 600 is backing up. Some RCTW systems include AEB to ensure that the vehicle brakes are applied to avoid a crash. RCTW systems may use one or more rear-facing RADAR sensor(s) 660, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 600, the vehicle 600 itself must, in the case of conflicting results, decide whether to heed the result from a primary computer or a secondary computer (e.g., a first controller 636 or a second controller 636). For example, in some embodiments, the ADAS system 638 may be a backup and/or secondary computer for providing perception information to a backup computer rationality module. The backup computer rationality monitor may run a redundant diverse software on hardware components to detect faults in perception and dynamic driving tasks. Outputs from the ADAS system 638 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 604.

In other examples, ADAS system 638 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 638 may be fed into the primary computer's perception block and/or the primary computer's dynamic driving task block. For example, if the ADAS system 638 indicates a forward crash warning due to an object immediately ahead, the perception block may use this information when identifying objects. In other examples, the secondary computer may have its own neural network which is trained and thus reduces the risk of false positives, as described herein.

The vehicle 600 may further include the infotainment SoC 630 (e.g., an in-vehicle infotainment system (IVI)). Although illustrated and described as a SoC, the infotainment system may not be a SoC, and may include two or more discrete components. The infotainment SoC 630 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 600. For example, the infotainment SoC 630 may radios, disk players, navigation systems, video players, USB and Bluetooth connectivity, carputers, in-car entertainment, Wi-Fi, steering wheel audio controls, hands free voice control, a heads-up display (HUD), an HMI display 634, a telematics device, a control panel (e.g., for controlling and/or interacting with various components, features, and/or systems), and/or other components. The infotainment SoC 630 may further be used to provide information (e.g., visual and/or audible) to a user(s) of the vehicle, such as information from the ADAS system 638, autonomous driving information such as planned vehicle maneuvers, trajectories, surrounding environment information (e.g., intersection information, vehicle information, road information, etc.), and/or other information.

The infotainment SoC 630 may include GPU functionality. The infotainment SoC 630 may communicate over the bus 602 (e.g., CAN bus, Ethernet, etc.) with other devices, systems, and/or components of the vehicle 600. In some examples, the infotainment SoC 630 may be coupled to a supervisory MCU such that the GPU of the infotainment system may perform some self-driving functions in the event that the primary controller(s) 636 (e.g., the primary and/or backup computers of the vehicle 600) fail. In such an example, the infotainment SoC 630 may put the vehicle 600 into a chauffeur to safe stop mode, as described herein.

The vehicle 600 may further include an instrument cluster 632 (e.g., a digital dash, an electronic instrument cluster, a digital instrument panel, etc.). The instrument cluster 632 may include a controller and/or supercomputer (e.g., a discrete controller or supercomputer). The instrument cluster 632 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 630 and the instrument cluster 632. In other words, the instrument cluster 632 may be included as part of the infotainment SoC 630, or vice versa.

FIG. 6D is a system diagram for communication between cloud-based server(s) and the example autonomous vehicle 600 of FIG. 6A, in accordance with some embodiments of the present disclosure. The system 676 may include server(s) 678, network(s) 690, and vehicles, including the vehicle 600. The server(s) 678 may include a plurality of GPUs 684(A)-684(H) (collectively referred to herein as GPUs 684), PCIe switches 682(A)-682(H) (collectively referred to herein as PCIe switches 682), and/or CPUs 680(A)-680(B) (collectively referred to herein as CPUs 680). The GPUs 684, the CPUs 680, and the PCIe switches may be interconnected with high-speed interconnects such as, for example and without limitation, NVLink interfaces 688 developed by NVIDIA and/or PCIe connections 686. In some examples, the GPUs 684 are connected via NVLink and/or NVSwitch SoC and the GPUs 684 and the PCIe switches 682 are connected via PCIe interconnects. Although eight GPUs 684, two CPUs 680, and two PCIe switches are illustrated, this is not intended to be limiting. Depending on the embodiment, each of the server(s) 678 may include any number of GPUs 684, CPUs 680, and/or PCIe switches. For example, the server(s) 678 may each include eight, sixteen, thirty-two, and/or more GPUs 684.

The server(s) 678 may receive, over the network(s) 690 and from the vehicles, image data representative of images showing unexpected or changed road conditions, such as recently commenced road-work. The server(s) 678 may transmit, over the network(s) 690 and to the vehicles, neural networks 692, updated neural networks 692, and/or map information 694, including information regarding traffic and road conditions. The updates to the map information 694 may include updates for the HD map 622, such as information regarding construction sites, potholes, detours, flooding, and/or other obstructions. In some examples, the neural networks 692, the updated neural networks 692, and/or the map information 694 may have resulted from new training and/or experiences represented in data received from any number of vehicles in the environment, and/or based on training performed at a datacenter (e.g., using the server(s) 678 and/or other servers).

The server(s) 678 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 690, and/or the machine learning models may be used by the server(s) 678 to remotely monitor the vehicles.

In some examples, the server(s) 678 may receive data from the vehicles and apply the data to up-to-date real-time neural networks for real-time intelligent inferencing. The server(s) 678 may include deep-learning supercomputers and/or dedicated AI computers powered by GPU(s) 684, such as a DGX and DGX Station machines developed by NVIDIA. However, in some examples, the server(s) 678 may include deep learning infrastructure that use only CPU-powered datacenters.

The deep-learning infrastructure of the server(s) 678 may be capable of fast, real-time inferencing, and may use that capability to evaluate and verify the health of the processors, software, and/or associated hardware in the vehicle 600. For example, the deep-learning infrastructure may receive periodic updates from the vehicle 600, such as a sequence of images and/or objects that the vehicle 600 has located in that sequence of images (e.g., via computer vision and/or other machine learning object classification techniques). The deep-learning infrastructure may run its own neural network to identify the objects and compare them with the objects identified by the vehicle 600 and, if the results do not match and the infrastructure concludes that the AI in the vehicle 600 is malfunctioning, the server(s) 678 may transmit a signal to the vehicle 600 instructing a fail-safe computer of the vehicle 600 to assume control, notify the passengers, and complete a safe parking maneuver.

For inferencing, the server(s) 678 may include the GPU(s) 684 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

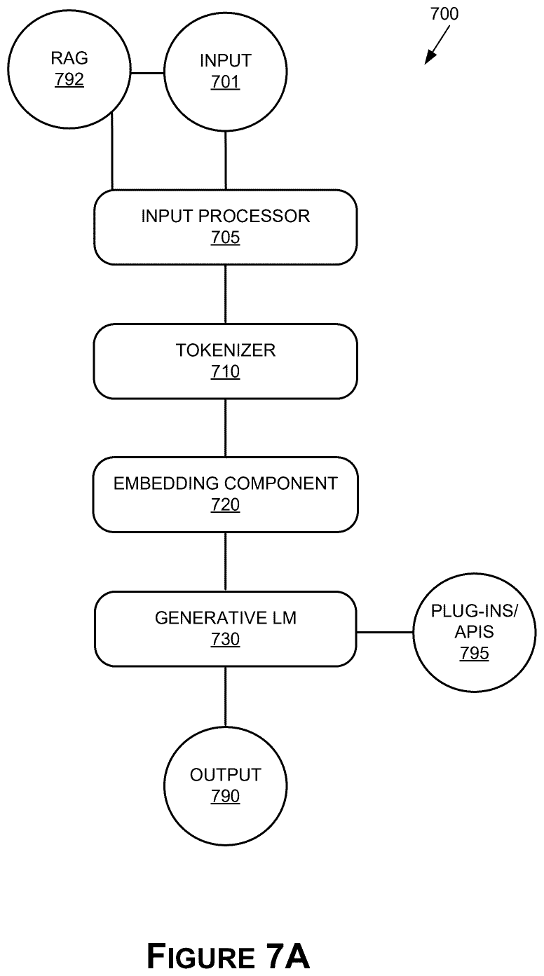

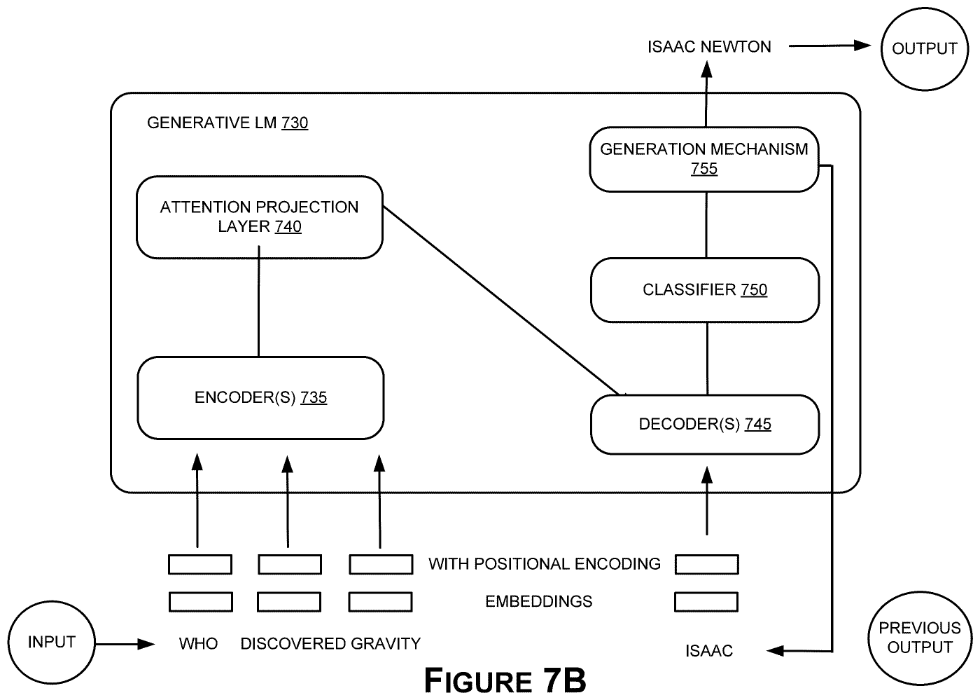

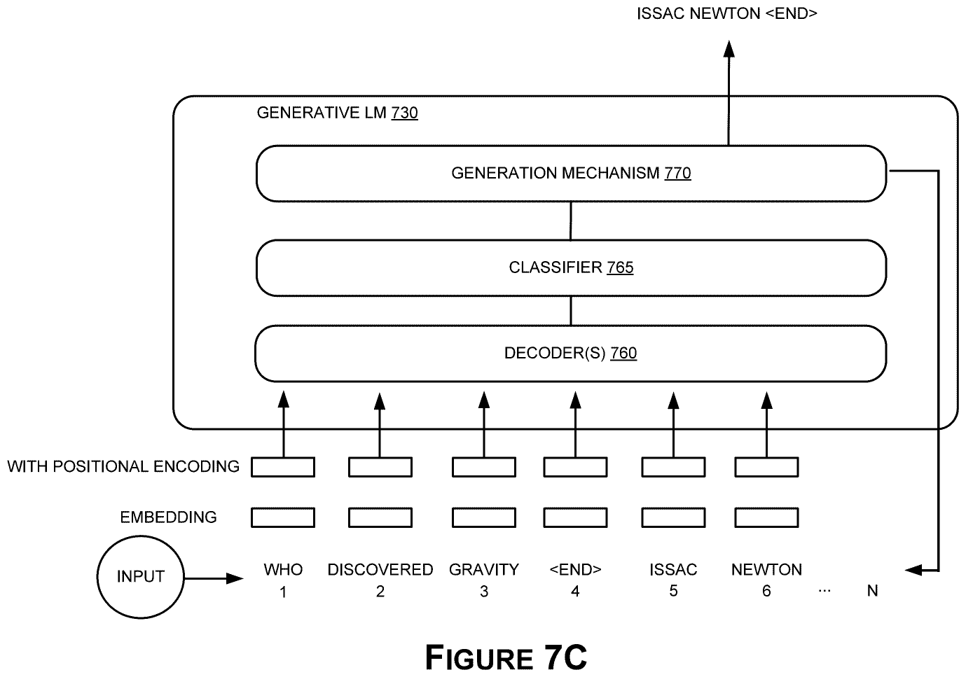

FIG. 7A is a block diagram of an example generative language model system 700 suitable for use in implementing at least some embodiments of the present disclosure. In the example illustrated in FIG. 7A, the generative language model system 700 includes a retrieval augmented generation (RAG) component 792, an input processor 705, a tokenizer 710, an embedding component 720, plug-ins/APIs 795, and a generative language model (LM) 730 (which may include an LLM, a VLM, a multi-modal LM, etc.).

At a high level, the input processor 705 may receive an input 701 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 730 (e.g., LLM/VLM/MMLM/etc.). In some embodiments, the input 701 includes plain text in the form of one or more sentences, paragraphs, and/or documents. Additionally or alternatively, the input 701 may include numerical sequences, precomputed embeddings (e.g., word or sentence embeddings), and/or structured data (e.g., in tabular formats, JSON, or XML). In some implementations in which the generative LM 730 is capable of processing multi-modal inputs, the input 701 may combine text (or may omit text) with image data, audio data, video data, design data, USD data, and/or other types of input data, such as but not limited to those described herein. Taking raw input text as an example, the input processor 705 may prepare raw input text in various ways. For example, the input processor 705 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 705 may remove stopwords to reduce noise and focus the generative LM 730 on more meaningful content. The input processor 705 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 792 (which may include one or more RAG models, and/or may be performed using the generative LM 730 itself) may be used to retrieve additional information to be used as part of the input 701 or prompt. RAG may be used to enhance the input to the LLM/VLM/MMLM/etc. with external knowledge, so that answers to specific questions or queries or requests are more relevant-such as in a case where specific knowledge is required. The RAG component 792 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 701 may be generated using the query or input to the model (e.g., a question, a request, etc.) in addition to data retrieved using the RAG component 792. In some embodiments, the input processor 705 may analyze the input 701 and communicate with the RAG component 792 (or the RAG component 792 may be part of the input processor 705, in embodiments) in order to identify relevant text and/or other data to provide to the generative LM 730 as additional context or sources of information from which to identify the response, answer, or output 790, generally. For example, where the input indicates that the user is interested in a desired tire pressure for a particular make and model of vehicle, the RAG component 792 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 792 may retrieve a prior stored conversation history- or at least a summary thereof- and include the prior conversation history along with the current ask/request as part of the input 701 to the generative LM 730.

The RAG component 792 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 792 and the embeddings of the chunks along with the embeddings of the query may be compared to identify the most similar/related embeddings to the query, which may be supplied to the generative LM 730 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 792 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 710 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 730 to understand morphological variations and handle out-of-vocabulary words more effectively. Character-based tokenization represents each character as a separate token, enabling the generative LM 730 to process text at a fine-grained level. The choice of tokenization strategy may depend on factors such as the language being processed, the task at hand, and/or characteristics of the training dataset. As such, the tokenizer 710 may convert the (e.g., processed) text into a structured format according to tokenization schema being implemented in the particular embodiment.

The embedding component 720 may use any known embedding technique to transform discrete tokens into (e.g., dense, continuous vector) representations of semantic meaning. For example, the embedding component 720 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 701 includes image data/video data/etc., the input processor 701 may resize the data to a standard size compatible with format of a corresponding input channel and/or may normalize pixel values to a common range (e.g., 0 to 1) to ensure a consistent representation, and the embedding component 720 may encode the image data using any known technique (e.g., using one or more convolutional neural networks (CNNs) to extract visual features). In some implementations in which the input 701 includes audio data, the input processor 701 may resample an audio file to a consistent sampling rate for uniform processing, and the embedding component 720 may use any known technique to extract and encode audio features-such as in the form of a spectrogram (e.g., a mel-spectrogram). In some implementations in which the input 701 includes video data, the input processor 701 may extract frames or apply resizing to extracted frames, and the embedding component 720 may extract features such as optical flow embeddings or video embeddings and/or may encode temporal information or sequences of frames. In some implementations in which the input 701 includes multi-modal data, the embedding component 720 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 730 and/or other components of the generative LM system 700 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 720 may apply an encoded representation of the input 701 to the generative LM 730, and the generative LM 730 may process the encoded representation of the input 701 to generate an output 790, which may include responsive text and/or other types of data.

As described herein, in some embodiments, the generative LM 730 may be configured to access or use—or capable of accessing or using—plug-ins/APIs 795 (which may include one or more plug-ins, application programming interfaces (APIs), databases, data stores, repositories, etc.). For example, for certain tasks or operations that the generative LM 730 is not ideally suited for, the model may have instructions (e.g., as a result of training, and/or based on instructions in a given prompt, such as those retrieved using the RAG component 792) to access one or more plug-ins/APIs 795 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 795 to the plug-in/API 795, the plug-in/API 795 may process the information and return an answer to the generative LM 730, and the generative LM 730 may use the response to generate the output 790. This process may be repeated—e.g., recursively—for any number of iterations and using any number of plug-ins/APIs 795 until an output 790 that addresses each ask/question/request/process/operation/etc. from the input 701 can be generated. As such, the model(s) may not only rely on its own knowledge from training on a large dataset(s) and/or from data retrieved using the RAG component 792, but also on the expertise or optimized nature of one or more external resources-such as the plug-ins/APIs 795.

FIG. 7B is a block diagram of an example implementation in which the generative LM 730 includes a transformer encoder-decoder. For example, assume input text such as “Who discovered gravity” is tokenized (e.g., by the tokenizer 710 of FIG. 7A) into tokens such as words, and each token is encoded (e.g., by the embedding component 720 of FIG. 7A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 735 of the generative LM 730.

In an example implementation, the encoder(s) 735 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 740 may convert the context vector into attention vectors (keys and values) for the decoder(s) 745.

In an example implementation, the decoder(s) 745 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 735, in an example transformer architecture, each token (e.g., word) flows through a separate path in the decoder(s) 745. During a first pass, the decoder(s) 745, a classifier 750, and a generation mechanism 755 may generate a first token, and the generation mechanism 755 may apply the generated token as an input during a second pass. The process may repeat in a loop, successively generating and adding tokens (e.g., words) to the output from the preceding pass and applying the token embeddings of the composite sequence with positional encodings as an input to the decoder(s) 745 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 735, except that it creates its queries from the layer below it and takes the keys and values (e.g., matrix) from the output of the encoder(s) 735.

As such, the decoder(s) 745 may output some decoded (e.g., vector) representation of the input being applied during a particular pass. The classifier 750 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 755 may select or sample a word or token based on a corresponding predicted probability (e.g., select the word with the highest predicted probability) and append it to the output from a previous pass, generating each word or token sequentially. The generation mechanism 755 may repeat the process, triggering successive decoder inputs and corresponding predictions until selecting or sampling a symbol or token that represents the end of the response, at which point, the generation mechanism 755 may output the generated response.

FIG. 7C is a block diagram of an example implementation in which the generative LM 730 includes a decoder-only transformer architecture. For example, the decoder(s) 760 of FIG. 7C may operate similarly as the decoder(s) 745 of FIG. 7B except each of the decoder(s) 760 of FIG. 7C omits the encoder-decoder self-attention layer (since there is no encoder in this implementation). As such, the decoder(s) 760 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 760. As with the decoder(s) 745 of FIG. 7B, each token (e.g., word) may flow through a separate path in the decoder(s) 760, and the decoder(s) 760, a classifier 765, and a generation mechanism 770 may use auto-regression to sequentially generate one token at a time until predicting a symbol or token that represents the end of the response. The classifier 765 and the generation mechanism 770 may operate similarly as the classifier 750 and the generation mechanism 755 of FIG. 7B, with the generation mechanism 770 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

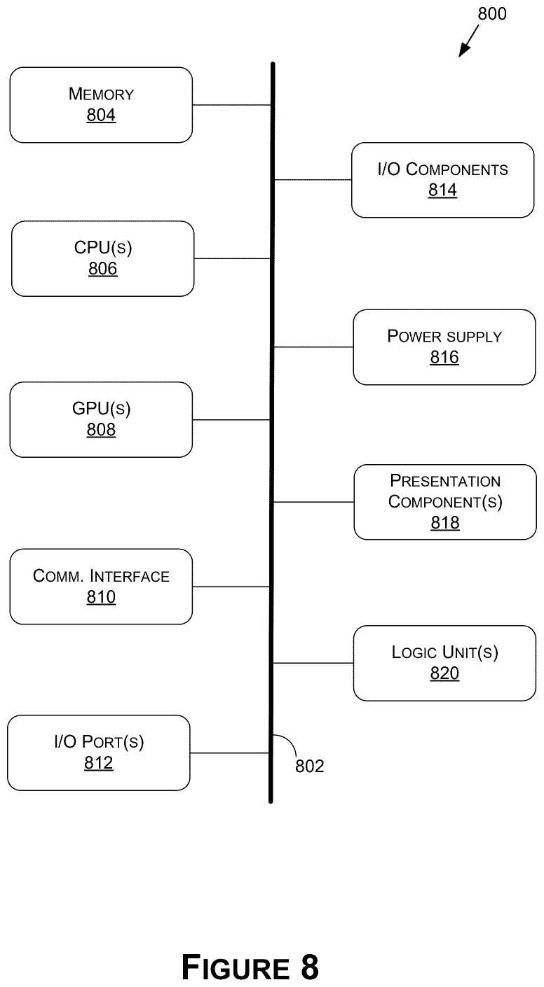

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). In other words, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

In various embodiments, one or more CPU(s) 606, GPU(s) 608, and/or logic unit(s) 1020 are configured to execute one or more instances of the sequence-to-sequence transformation application 146 and/or transducer model 150.

The communication interface 810 may include one or more receivers, transmitters, and/or transceivers that enable the computing device 800 to communicate with other computing devices via an electronic communication network, included wired and/or wireless communications. The communication interface 810 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may enable the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that enable detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to enable the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

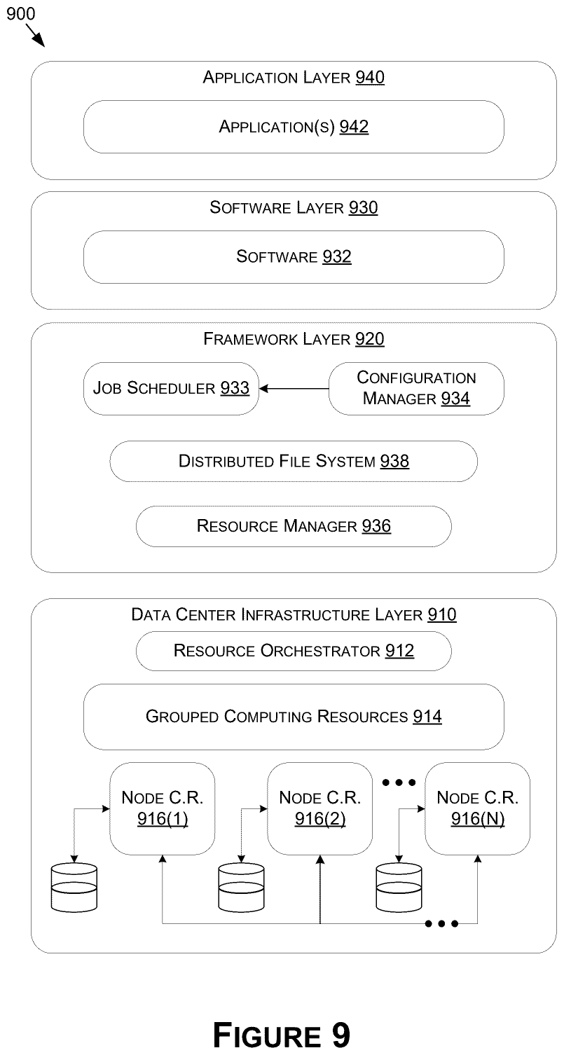

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 933, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 933 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 933. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

1. In some embodiments, a method comprises encoding a sequence of inputs into a representation of the sequence of inputs, based at least on the representation of the sequence of inputs and without a history of previously predicted output labels, causing the generation of a sequence of joint probabilities, wherein each joint probability of the sequence of joint probabilities is computed based at least on a respective first probability distribution over a set of output labels and a respective second probability distribution over a set of allowed durations, and causing the generation of a sequence of output labels based at least on the sequence of joint probabilities.

2. The method of clause 1, further comprising receiving the sequence of inputs.

3. The method of clause 1 or 2, further comprising updating the sequence of output labels by removing blank output labels from the sequence of output labels.

4. The method of any of clauses 1-3, wherein the set of output labels includes a set of non-blank output labels and at least one blank output label.

5. The method of any of clauses 1-4, wherein individual allowed durations of the set of allowed durations indicates a possible number of inputs that are allowed to be processed to generate an output label.

6. The method of any of clauses 1-5, wherein the sequence of inputs includes a sequence of audio frames and the sequence of outputs includes a sequence of text.

7. The method of any of clauses 1-6, wherein training the machine learning model comprises, for each sequence of training inputs and a corresponding sequence of training output labels encoding the sequence of training inputs into a first representation of the sequence of training inputs, generating a second representation of a sequence of predicted output labels based at least on the sequence of training output labels, masking portions of the second representation at random according to a probability, based at least on a determination that the portions of the second representation are masked, causing the generation of a first set of joint probabilities based at least on the first representation and the masked second representation, wherein each joint probability of the first set of joint probabilities is computed based at least on a respective third probability distribution over the set of output labels and a respective fourth probability distribution over the set of allowed durations, and refining the machine learning model according to a loss function that is computed based at least on the set of joint probabilities.

8. The method of any of clauses 1-7, wherein the training the machine learning model further comprises, based at least on a determination that no portions of the second representation are masked, causing the generation of a second set of joint probabilities based at least on the first representation and the second representation, wherein each joint probability of the second set of joint probabilities is computed based at least on a respective fifth probability distribution over the set of output labels and a respective sixth probability distribution over the set of allowed durations.

9. In some embodiments, at least one processor comprises one or more circuits to encode a sequence of inputs into a representation of the sequence of inputs, based at least on the representation of the sequence of inputs and without a history of previously predicted output labels, cause the generation of a sequence of joint probabilities, wherein individual joint probabilities of the sequence of joint probabilities are computed based at least on a respective first probability distribution over a set of output labels and a respective second probability distribution over a set of allowed durations, and cause the generation of a sequence of output labels based at least on the sequence of joint probabilities.

10. The at least one processor of clause 9, wherein the at least one processor is comprised in at least one of a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system for generating or presenting at least one of virtual reality content, augmented reality content, or mixed reality content; a system implemented using a robot; a system for performing conversational AI operations; a system implementing one or more large language models; a system implementing one or more vision language models (VLMs); a system implementing one or more multi-modal language models (MMLMs); a system implementing one or more machine learning models using as an inference microservice including the one or more machine learning models and one or more operation system (OS)-level virtualization packages; a system for generating synthetic data; a system incorporating one or more virtual machines (VMs); a system implemented at least partially in a data center; or a system implemented at least partially using cloud computing resources.

11. The at least one processor of any of clauses 9-10, wherein the one or more circuits further receive the sequence of inputs.

12. The at least one processor of any of clauses 9-11, wherein the one or more circuits further update the sequence of output labels by removing blank output labels from the sequence of output labels.

13. The at least one processor of any of clauses 9-12, wherein the set of output labels includes a set of non-blank output labels and at least one blank output label.

14. The at least one processor of any of clauses 9-13, wherein individual allowed durations of the set of allowed durations indicates a possible number of inputs that are allowed to be processed to generate an output label.

15. The at least one processor of any of clauses 9-14, wherein the sequence of inputs includes a sequence of audio frames and the sequence of outputs includes a sequence of text.

16. The at least one processor of any of clauses 9-15, wherein the one or more circuits further train the machine learning model, wherein the training, for each sequence of training inputs and a corresponding sequence of training output labels, comprises: encoding the sequence of training inputs into a first representation of the sequence of training inputs; generating a second representation of a sequence of predicted output labels based at least on the sequence of training output labels; masking portions of the second representation at random according to a probability; based at least on a determination that the portions of the second representation are masked, causing the generation of a first set of joint probabilities based at least on the first representation and the masked second representation, wherein individual joint probabilities of the first set of joint probabilities are computed based at least on a respective third probability distribution over the set of output labels and a respective fourth probability distribution over the set of allowed durations; and refining the machine learning model according to a loss function that is computed based at least on the set of joint probabilities.

17. The at least one processor of any of clauses 9-16, wherein the training of the machine learning model further comprises, based at least on a determination that no portions of the second representation are masked, causing the generation of a second set of joint probabilities based at least on the first representation and the second representation, wherein individual joint probabilities of the second set of joint probabilities are computed based at least on a respective fifth probability distribution over the set of output labels and a respective sixth probability distribution over the set of allowed durations.

18. In some embodiments, a system comprises one or more processing units to execute operations comprising: encoding a sequence of inputs into a representation of the sequence of inputs; based at least on the representation of the sequence of inputs and without a history of previously predicted output labels, causing generation of a sequence of joint probabilities, wherein individual joint probabilities of the sequence of joint probabilities are computed based at least on a respective first probability distribution over a set of output labels and a respective second probability distribution over a set of allowed durations; causing the generation of a sequence of output labels based at least on the sequence of joint probabilities.

19. The system of clause 18, wherein the one or operations further comprise training the machine learning model, wherein the training, for each sequence of training inputs and a corresponding sequence of training output labels, comprises: encoding the sequence of training inputs into a first representation of the sequence of training inputs; generating a second representation of a sequence of predicted output labels based at least on the sequence of training output labels; masking portions of the second representation at random according to a probability; based at least on a determination that the portions of the second representation are masked, causing the generation of a first set of joint probabilities based at least on the first representation and the masked second representation, wherein individual joint probabilities of the first set of joint probabilities are computed based at least on a respective third probability distribution over the set of output labels and a respective fourth probability distribution over the set of allowed durations; and refining the machine learning model according to a loss function that is computed based at least on the set of joint probabilities.

20. The system of any of clauses 18-19, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system for generating or presenting at least one of virtual reality content, augmented reality content, or mixed reality content; a system implemented using a robot; a system for performing conversational AI operations; a system implementing one or more large language models; a system implementing one or more vision language models (VLMs); a system implementing one or more multi-modal language models (MMLMs); a system implementing one or more machine learning models using as an inference microservice including the one or more machine learning models and one or more operation system (OS)-level virtualization packages; a system for generating synthetic data; a system incorporating one or more virtual machines (VMs); a system implemented at least partially in a data center; or a system implemented at least partially using cloud computing resources.

Any and all combinations of any of the claim elements recited in any of the claims and/or any elements described in this application, in any fashion, fall within the contemplated scope of the present invention and protection.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
encoding a sequence of inputs into a representation of the sequence of inputs;
based at least on the representation of the sequence of inputs and without a history of previously predicted output labels, causing the generation of a sequence of joint probabilities, wherein each joint probability of the sequence of joint probabilities is computed based at least on a respective first probability distribution over a set of output labels and a respective second probability distribution over a set of allowed durations; and
causing the generation of a sequence of output labels based at least on the sequence of joint probabilities.

2. The method of claim 1, further comprising receiving the sequence of inputs.

3. The method of claim 1, further comprising updating the sequence of output labels by removing blank output labels from the sequence of output labels.

4. The method of claim 1, wherein the set of output labels includes a set of non-blank output labels and at least one blank output label.

5. The method of claim 1, wherein individual allowed durations of the set of allowed durations indicates a possible number of inputs that are allowed to be processed to generate an output label.

6. The method of claim 1, wherein the sequence of inputs includes a sequence of audio frames and the sequence of outputs includes a sequence of text.

7. The method of claim 1, wherein training the machine learning model comprises, for each sequence of training inputs and a corresponding sequence of training output labels:
encoding the sequence of training inputs into a first representation of the sequence of training inputs;
generating a second representation of a sequence of predicted output labels based at least on the sequence of training output labels;
masking portions of the second representation at random according to a probability;
based at least on a determination that the portions of the second representation are masked, causing the generation of a first set of joint probabilities based at least on the first representation and the masked second representation, wherein each joint probability of the first set of joint probabilities is computed based at least on a respective third probability distribution over the set of output labels and a respective fourth probability distribution over the set of allowed durations; and
refining the machine learning model according to a loss function that is computed based at least on the set of joint probabilities.

8. The method of claim 7, wherein the training the machine learning model further comprises, based at least on a determination that no portions of the second representation are masked, causing the generation of a second set of joint probabilities based at least on the first representation and the second representation, wherein each joint probability of the second set of joint probabilities is computed based at least on a respective fifth probability distribution over the set of output labels and a respective sixth probability distribution over the set of allowed durations.

9. At least one processor comprising:
one or more circuits to:
encode a sequence of inputs into a representation of the sequence of inputs;
based at least on the representation of the sequence of inputs and without a history of previously predicted output labels, cause the generation of a sequence of joint probabilities, wherein individual joint probabilities of the sequence of joint probabilities are computed based at least on a respective first probability distribution over a set of output labels and a respective second probability distribution over a set of allowed durations; and
cause the generation of a sequence of output labels based at least on the sequence of joint probabilities.

10. The at least one processor of claim 9, wherein the at least one processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, augmented reality content, or mixed reality content;
a system implemented using a robot;
a system for performing conversational AI operations;
a system implementing one or more large language models;
a system implementing one or more vision language models (VLMs);
a system implementing one or more multi-modal language models (MMLMs);
a system implementing one or more machine learning models using as an inference microservice including the one or more machine learning models and one or more operation system (OS)-level virtualization packages;
a system for generating synthetic data;
a system incorporating one or more virtual machines (VMs);
a system implemented at least partially in a data center; or
a system implemented at least partially using cloud computing resources.

11. The at least one processor of claim 9, wherein the one or more circuits further receive the sequence of inputs.

12. The at least one processor of claim 9, wherein the one or more circuits further update the sequence of output labels by removing blank output labels from the sequence of output labels.

13. The at least one processor of claim 9, wherein the set of output labels includes a set of non-blank output labels and at least one blank output label.

14. The at least one processor of claim 9, wherein individual allowed durations of the set of allowed durations indicates a possible number of inputs that are allowed to be processed to generate an output label.

15. The at least one processor of claim 9, wherein the sequence of inputs includes a sequence of audio frames and the sequence of outputs includes a sequence of text.

16. The at least one processor of claim 9, wherein the one or more circuits further train the machine learning model, wherein the training, for each sequence of training inputs and a corresponding sequence of training output labels, comprises:
encoding the sequence of training inputs into a first representation of the sequence of training inputs;
generating a second representation of a sequence of predicted output labels based at least on the sequence of training output labels;
masking portions of the second representation at random according to a probability;
based at least on a determination that the portions of the second representation are masked, causing the generation of a first set of joint probabilities based at least on the first representation and the masked second representation, wherein individual joint probabilities of the first set of joint probabilities are computed based at least on a respective third probability distribution over the set of output labels and a respective fourth probability distribution over the set of allowed durations; and
refining the machine learning model according to a loss function that is computed based at least on the set of joint probabilities.

17. The at least one processor of claim 16, wherein the training of the machine learning model further comprises, based at least on a determination that no portions of the second representation are masked, causing the generation of a second set of joint probabilities based at least on the first representation and the second representation, wherein individual joint probabilities of the second set of joint probabilities are computed based at least on a respective fifth probability distribution over the set of output labels and a respective sixth probability distribution over the set of allowed durations.

18. A system comprising:
one or more processing units to execute operations comprising:
encoding a sequence of inputs into a representation of the sequence of inputs;
based at least on the representation of the sequence of inputs and without a history of previously predicted output labels, causing generation of a sequence of joint probabilities, wherein individual joint probabilities of the sequence of joint probabilities are computed based at least on a respective first probability distribution over a set of output labels and a respective second probability distribution over a set of allowed durations; and
causing the generation of a sequence of output labels based at least on the sequence of joint probabilities.

19. The system of claim 18, wherein the one or operations further comprise training the machine learning model, wherein the training, for each sequence of training inputs and a corresponding sequence of training output labels, comprises:
encoding the sequence of training inputs into a first representation of the sequence of training inputs;
generating a second representation of a sequence of predicted output labels based at least on the sequence of training output labels;
masking portions of the second representation at random according to a probability;
based at least on a determination that the portions of the second representation are masked, causing the generation of a first set of joint probabilities based at least on the first representation and the masked second representation, wherein individual joint probabilities of the first set of joint probabilities are computed based at least on a respective third probability distribution over the set of output labels and a respective fourth probability distribution over the set of allowed durations; and
refining the machine learning model according to a loss function that is computed based at least on the set of joint probabilities.

20. The system of claim 18, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, augmented reality content, or mixed reality content;
a system implemented using a robot;
a system for performing conversational AI operations;
a system implementing one or more large language models;
a system implementing one or more vision language models (VLMs);
a system implementing one or more multi-modal language models (MMLMs);
a system implementing one or more machine learning models using as an inference microservice including the one or more machine learning models and one or more operation system (OS)-level virtualization packages;
a system for generating synthetic data;
a system incorporating one or more virtual machines (VMs);
a system implemented at least partially in a data center; or
a system implemented at least partially using cloud computing resources.
